(19) United States
(12) Patent Application Publication
(10) Pub. No.: US 2026/0072789 A1
(43) Pub. Date: Mar. 12, 2026

(54) MAGNETIC DISK DEVICE

(71) Applicants: Kabushiki Kaisha Toshiba, Tokyo (JP); Toshiba Electronic Devices & Storage Corporation, Tokyo (JP)

(72) Inventor: Yusuke TOMODA, Yokohama Kanagawa (JP)

(21) Appl. No.: 19/033,361

(22) Filed: Jan. 21, 2025

(30) Foreign Application Priority Data
Sep. 12, 2024 (JP) 2024-158385

(51) Int. Cl. G06F 11/10; G11B 5/55; G11B 20/12

(52) U.S. Cl. CPC G06F 11/1076; G11B 5/5547; G11B 20/1217; G11B 2020/1238

(57) ABSTRACT

According to one embodiment, during a first write period, if determining that error correction of first user data does not exceed a limit, a determination unit causes a write processing unit to continue write processing and causes a management unit to execute second management. If determining that the error correction exceeds the limit, the determination unit causes the write processing unit to continue the write processing and causes the management unit to execute third management. During the first write period or after the first write period, the determination unit causes the management unit to execute processing of saving data belonging to a third group to a nonvolatile recording medium.

### CROSS-REFERENCE TO RELATED APPLICATIONS

This application is based upon and claims the benefit of priority from Japanese Patent Application No. 2024-158385, filed Sep. 12, 2024, the entire contents of which are incorporated herein by reference.

### FIELD

Embodiments described herein relate generally to a magnetic disk device.

### BACKGROUND

Magnetic disk devices such as a Conventional Magnetic Recording (CMR) (or conventional recording) magnetic disk device that writes data to a plurality of tracks at intervals in the radial direction of the disk, a Shingled Magnetic Recording (SMR) magnetic disk device that overwrites data to a plurality of tracks in the radial direction of the disk, and a hybrid recording type magnetic disk device that selectively executes the conventional magnetic recording and the shingled magnetic recording, are known.

### BRIEF DESCRIPTION OF THE DRAWINGS

FIG. 1 is a block diagram showing a configuration of a magnetic disk device according to an embodiment.

FIG. 2 is a perspective view showing parts of the magnetic disk device, illustrating a plurality of disks and a plurality of heads.

FIG. 3 is a schematic diagram showing an example of arrangement of a plurality of servo areas and a plurality of data areas on a single disk according to the embodiment.

FIG. 4 is a schematic diagram showing three tracks in the user data area where shingled magnetic recording processing of the disk shown in FIG. 3 is executed, together with a write head.

FIG. 5 is a schematic diagram showing three tracks of a media cache where conventional magnetic recording processing of the disk shown in FIG. 3 is executed, together with a write head.

FIG. 6 is a schematic diagram showing an example of data write processing on the disk.

FIG. 7 is a schematic diagram showing two bands and one guard band of the user data area shown in FIG. 6.

FIG. 8 is a schematic diagram showing three sectors of one track of the band shown in FIG. 6.

FIG. 9 is a schematic diagram showing two bands and one guard band shown in FIG. 7, illustrating a plurality of target sectors and a plurality of unused sectors.

FIG. 10 is a schematic diagram showing an example of the first track and the second track in a case where it is assumed that the above-described magnetic disk device does not comprise a function of executing track-based error correction for track data, illustrating the write processing for the first track and the second track, illustrating a state in which the write processing for the second track is continued until the sector-based error correction for the first track reaches its limit, and illustrating each of the change in BER for the first track and the change in BER for the positioning error in graph form.

FIG. 11 is a schematic diagram showing an example of the first track and second track in a case where it is assumed that the magnetic disk device does not comprise a function of executing track-based error correction for the track data, illustrating the write processing for the first track and the second track, illustrating a state in which a determination value is set to a write-off track slice smaller (more severe) than the track margin and the write processing for the second track is ended when a positioning error exceeds a reference radius position, and illustrating each of the change in BER for the first track and the change in BER for the positioning error in graph form.

FIG. 12 is a schematic diagram showing an example of the first track and second track of a magnetic disk device that comprises a function of executing track-based error correction for the track data, illustrating the write processing for the first track and the second track, illustrating a state in which a determination value is set to a write-off track slice greater (more loose) than the track margin and the write processing for the second track is continued until track-based error correction for the first track exceeds a limit, and illustrating each of the change in BER for the first track and the change in BER for the positioning error in graph form.

FIG. 13 is a table showing the presence or absence of a track ECC, the name of the function that controls DOL, the contents of the processing in a case where the positioning error exceeds the reference radius position, settings on overwriting to the data in the buffer memory, and settings on saving the data in the buffer memory, in the first write operation and the first and second methods of the second write operation.

FIG. 14 is a chart showing the change in positioning error and the change in cumulative number of corrupted target sectors in a case of executing the write processing for the second track in the first method of the second write operation, and showing a case where the cumulative number exceeds a PTS activation threshold value during the write processing for the n-th target sector of the second track.

FIG. 15 is a chart showing the change in positioning error and the change in cumulative number of corrupted target sectors in a case of executing the write processing for the second track in the second method of the second write operation, and showing a case where the cumulative number exceeds an upper limit number during the write processing for the n-th target sector of the second track.

FIG. 16 is a chart showing the change in positioning error and the change in cumulative actual excess amount in a case of executing the write processing for the second track in the second method of the second write operation, and showing a case where the cumulative actual excess amount exceeds an upper limit threshold value during the write processing for the n-th target sector of the second track.

FIG. 17 is a flowchart showing a write processing method for an n-th target sector of the second track, of the write processing method for the above-described embodiment, illustrating a case where the above-described magnetic disk device adopts the second method of the second write operation during the first write period.

FIG. 18 is a flowchart showing the above-described write processing method, following FIG. 17.

FIG. 19 is a flowchart showing a modified example of the above-described write processing method, following FIG. 17.

### DETAILED DESCRIPTION

In general, according to one embodiment, there is provided a magnetic disk device comprising: a disk including a first data track and a second data track adjacent to each other in a recording layer, the first data track and the second data track each including a plurality of target sectors being targets to which data is to be written, the first data track being located in a first direction parallel to a radial direction of the disk as viewed from the second data track; a head including a write head writing data to the recording layer and a read head reading data from the recording layer; a read processing unit capable of executing seek processing of causing the read head to seek; a write processing unit capable of executing write processing of writing data to the recording layer; an error correction unit executing error correction of data in one or more corrupted target sectors in which data is considered to be corrupted, among the plurality of target sectors of the first data track; a buffer memory capable of holding a plurality of elements of data including first user data and second user data; a management unit capable of selectively executing first management of prohibiting overwrite to the first user data in the buffer memory, second management of permitting overwrite to all elements of the first user data in the buffer memory, and third management of permitting overwrite to data belonging to a first group and a second group among the first user data in the buffer memory and prohibiting overwrite to data belonging to a third group among the first user data in the buffer memory; a correction limit discrimination unit; and a determination unit. During a first write period being a period elapsed after the write processing unit executes the write processing of writing first data including the first user data to the plurality of target sectors of the first data track, and the period during which the write processing unit executes the write processing of writing second data including the second user data to the plurality of target sectors of the second data track, the read processing unit executes seek processing of causing the read head to seek and makes the write head face the second data track, each time data is written to each of the target sectors of the second data track, the correction limit discrimination unit obtains information that a position of the write head is displaced beyond a reference radius position in the first direction, and the management unit executes the first management, and if determining that the error correction of the first user data on the first data track, which is executed by the error correction unit, does not exceed a limit, based on the information obtained by the correction limit discrimination unit, the determination unit causes the write processing unit to continue the write processing for the second data track and causes the management unit to execute the second management instead of the first management, and if determining that the error correction of the first user data on the first data track, which is executed by the error correction unit, exceeds the limit, based on the information, the determination unit causes the write processing unit to continue the write processing for the second data track and causes the management unit to execute the third management instead of the first management. During the first write period or after the first write period, the determination unit causes the management unit to execute processing of saving data belonging to the third group to a nonvolatile recording medium. The data belonging to the first group is original data of the data of one or more target sectors in which the data is determined to be uncorrupted, among the plurality of target sectors of the first data track. The data belonging to the second group is original data of the data of one or more first corrupted target sectors in which the data is determined to be corrupted, among the plurality of target sectors of the first data track, and original data of the data within a range of being subjected to the error correction executed by the error correction unit. The data belonging to the third group is original data of the data of one or more second corrupted target sectors in which the data is determined to be corrupted, among the plurality of target sectors of the first data track, and original data of the data which leaks from the range of being subjected to the error correction executed by the error correction unit.

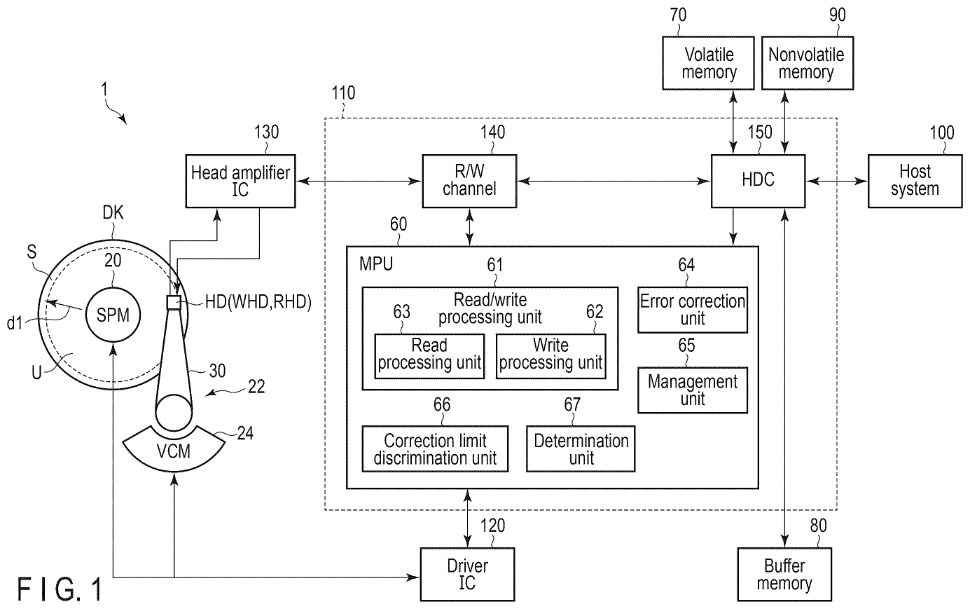

A magnetic disk device 1 according to one embodiment will be described hereinafter with reference to the accompanying drawings. First, a configuration of the magnetic disk device 1 will be described. FIG. 1 is a block diagram showing the configuration of the magnetic disk device 1 according to the embodiment. In the embodiment, the magnetic disk device 1 is a hybrid recording magnetic disk device that selectively executes the conventional magnetic recording and the shingled magnetic recording. However, a technique to be described below may be applied to a magnetic disk device of the shingled magnetic recording or a magnetic disk device of the conventional magnetic recording.

As shown in FIG. 1, the magnetic disk device 1 comprises a plurality of, for example, one to ten disks (magnetic disks) DK serving as recording medium, a spindle motor (SPM) 20 serving as a drive motor, a head stack assembly 22, a driver IC 120, a head amplifier integrated circuit (hereinafter referred to as a head amplifier IC or preamplifier) 130, a volatile memory 70, a buffer memory (buffer) 80, a nonvolatile memory 90, and a system controller 110 that is a single-chip integrated circuit. In addition, the magnetic disk device 1 is connected to a host system (hereinafter simply referred to as a host) 100.

Each of the disks DK is formed to have a diameter of, for example, 97 mm (3.8 inches) and has recording layers (magnetic recording layers) on both sides. Incidentally, in the embodiment, the magnetic disk device 1 comprises one to eleven disks DK, but the number of disks DK is not limited to this.

The head stack assembly 22 can control a head HD mounted on an arm 30 to move, i.e., seek to a target position on the disk DK by driving a voice coil motor (hereinafter referred to as VCM) 24. The VCM 24 functions as an actuator.

A user data area U that can be used by the user, and a system area S where information necessary for the system management is written are assigned to the area of the disk DK where the data can be written.

The head HD records and reproduces information on the disk DK. The head HD comprises a write head WHD and a read head RHD mounted on a slider as a main body. The write head WHD writes the data to the recording layer of the disk DK. The read head RHD reads the data from data tracks of the recording layer of the disk DK.

The “central part of the head HD” may be referred to as the “head HD”, the “central part of the write head WHD” may be referred to as the “write head WHD”, and the “central part of the read head RHD” may be referred to as the “read head RHD”. The “central part of the write head WHD” may be simply referred to as the “head HD”, and the “central part of the read head RHD”may be simply referred to as the “head HD”.

The driver IC 120 controls driving the SPM 20 and the VCM 24 under control of the system controller 110 (more specifically, MPU 60 to be described later). The SPM 20 supports and rotates a plurality of disks DK.

The head amplifier IC 130 comprises a read amplifier and a write driver. The read amplifier amplifies a read signal read from the disk DK and outputs the amplified read signal to the system controller 110 (more specifically, a read/write (R/W) channel 140 to be described later). The write driver outputs a write current corresponding to a signal output from the R/W channel 140 to the head HD.

The volatile memory 70 is a semiconductor memory where the stored data is lost when power supply is cut off. The volatile memory 70 stores data necessary for processing in each unit of the magnetic disk device 1, and the like. The volatile memory 70 is a random access memory (RAM). The volatile memory 70 is, for example, a dynamic random access memory (DRAM). However, the volatile memory 70 may be a synchronous dynamic random access memory (SDRAM).

The buffer memory 80 is a semiconductor memory which temporarily records data transmitted and received between the magnetic disk device 1 and the host 100, and the like. Incidentally, the buffer memory 80 may be formed integrally with the volatile memory 70. The buffer memory 80 is a volatile RAM. Examples of the buffer memory 80 are a DRAM, a static random access memory (SRAM), an SDRAM, a ferroelectric random access memory (FeRAM), a magnetoresistive random access memory (MRAM), and the like.

The buffer memory 80 includes areas used as a read cache and a write cache, and temporarily stores commands and the like, which are received from the host 100.

The nonvolatile memory 90 is a semiconductor memory which records data stored even when power supply is cut off. The nonvolatile memory 90 is, for example, a NAND flash read only memory (FROM). However, the nonvolatile memory 90 may also be a NOR FROM.

The system controller (controller) 110 is realized by using, for example, a large scale integrated circuit (LSI) referred to as a system-on-a-chip (SoC) in which a plurality of elements are integrated on a single chip. The system controller 110 includes a read/write (R/W) channel 140, a hard disk controller (HDC) 150, and a microprocessor (MPU) 60. The system controller 110 is electrically connected to the driver IC 120, the head amplifier IC 130, the volatile memory 70, the buffer memory 80, the nonvolatile memory 90, and the host 100.

The R/W channel 140 executes signal processing of read data transferred from the disk DK to the host 100 and write data transferred from the host 100 in accordance with instructions from the MPU 60 to be described later. The R/W channel 140 comprises a circuit or function of modulating the write data. In addition, the R/W channel 140 comprises a circuit or a function of measuring the signal quality of the read data. The R/W channel 140 is electrically connected to, for example, the head amplifier IC 130, the HDC 150, the MPU 60 and the like.

The HDC 150 controls data transfer between the host 100 and the R/W channel 140 in accordance with instructions from the MPU 60. The HDC 150 is electrically connected to, for example, the R/W channel 140, the MPU 60, the volatile memory 70, the buffer memory 80, the nonvolatile memory 90, and the like.

The HDC 150 includes a gate generation unit. In accordance with commands from the host 100, instructions from the MPU 60, and the like, the gate generation unit generates various gates, for example, a write gate, a read gate, a servo gate, and the like and outputs the gates to the R/W channel 140, for example, the gate detection unit. In the following descriptions, “activating a predetermined gate” may be referred to as “asserting a predetermined gate”. In addition, “falling down a predetermined gate” may be referred to as “negating the predetermined gate”. In addition, “asserting a predetermined gate” and “negating a predetermined gate” may imply the meaning “generating a predetermined gate”. Incidentally, the gate generation unit may be included in the R/W channel 140 or the MPU 60.

The R/W channel 140 includes a gate detection unit. The gate detection unit detects whether various gates, for example, the write gate, the read gate, the servo gate, and the like are in an asserted state or a negated state.

For example, the gate detection unit executes the write processing when detecting that the write gate is asserted, and suspends (stops) the write processing when detecting that the write gate is negated.

In addition, the gate detection unit executes the read processing when detecting that the read gate is asserted, and stops the read processing when detecting that the read gate is negated. The gate detection unit executes the servo read processing when detecting that the servo gate is asserted, and stops the servo read processing when detecting that the servo gate is negated. Incidentally, the gate detection unit may be provided inside the HDC 150 or the MPU 60.

The MPU 60 is a control unit or main controller which controls each of units of the magnetic disk device 1. The MPU 60 controls the VCM 24 via the driver IC 120 to execute servo control for positioning the head HD. The MPU 60 controls the operation of writing the data to the disk DK and selects a storage destination of the write data transferred from the host 100. In addition, the MPU 60 controls the operation of reading the data from the disk DK and controls the processing of the read data transferred from the disk DK to the host 100. The MPU 60 is connected to each of units of the magnetic disk device 1. The MPU 60 is electrically connected to, for example, the driver IC 120, the R/W channel 140, the HDC 150 and the like.

The MPU 60 comprises a read/write processing unit 61, an error correction unit 64, a management unit 65, a correction limit discrimination unit 66, a determination unit 67, and the like. The MPU 60 executes the processing of each of these units, for example, the read/write processing unit 61, the error correction unit 64, the management unit 65, the correction limit discrimination unit 66, the determination unit 67, and the like on firmware. Incidentally, the MPU 60 may comprise each of these units as a circuit.

The read/write processing unit 61 includes a write processing unit 62 and a read processing unit 63. In accordance with commands from the host 100, the write processing unit 62 controls the data write processing, and the read processing unit 63 controls the data read processing, causing the read head RHD to execute reading the data from the disk DK. The read processing unit 63 is capable of executing seek processing to cause the read head RHD to seek. The write processing unit 62 is capable of executing write processing to write data to the recording layer of the disk DK. The read/write processing unit 61 controls the VCM 24 via the driver IC 120, positions the head HD at a target position (predetermined radial position) on the disk DK, and executes the read processing or the write processing.

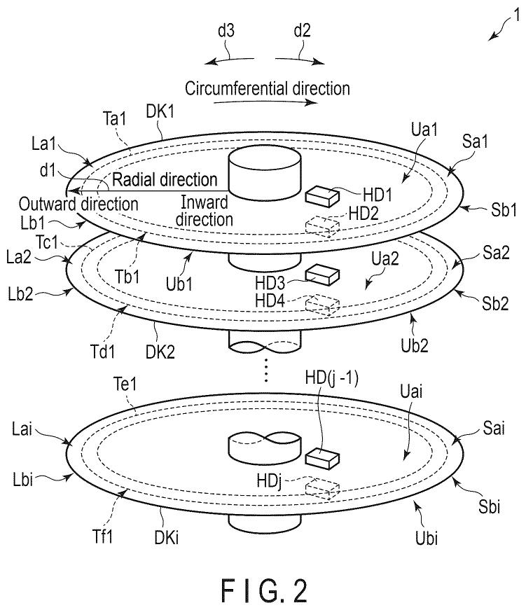

FIG. 2 is a perspective view showing parts of the magnetic disk device 1, illustrating a plurality of disks DK and a plurality of heads HD.

As shown in FIG. 2, the direction of rotation of the disks DK in the circumferential direction is referred to as a rotational direction d3. Incidentally, in the example shown in FIG. 2, the rotational direction d3 is illustrated as a counterclockwise direction, but may be an opposite (clockwise) direction. In addition, a traveling direction d2 of the heads HD relative to the disks DK is opposite to the rotational direction d3. The traveling direction d2 is the direction in which the heads HD sequentially write the data to and read data from the disks DK in the circumferential direction, i.e., the direction in which the heads HD travel with respect to the disks DK in the circumferential direction.

The magnetic disk device 1 comprises i disks, from disk DK1 through disk DKi, and j heads, from head HD1 through head HDj. In the embodiment, the number of heads HD is twice the number of disks DK (j=2×i).

The disks DK1 through DKi are provided coaxially to overlap with each other at intervals. The diameters of the disks DK1 to DKi are the same as each other. The terms “same”, “equal”, “matching”, “equivalent” and the like imply not only the meaning of being exactly the same, but also the meaning of being different to the extent that they can be regarded as substantially the same. Incidentally, the diameters of the disks DK1 to DKi may be different from each other.

Each disk DK has recording layers L on both sides. For example, the disk DK1 has a first recording layer La1 and a second recording layer Lb1 on the side opposite to the first recording layer La1. The disk DK2 has a first recording layer La2 and a second recording layer Lb2 on the side opposite to the first recording layer La2. The disk DKi has a first recording layer Lai and a second recording layer Lbi on the side opposite to the first recording layer Lai. Each first recording layer La may be referred to as a top surface or a recording surface. Each second recording layer Lb may be referred to as a back surface or recording surface.

However, each first recording layer La may be referred to as a back surface. In this case, each second recording layer Lb may be referred to as a top surface.

Each recording layer L has a user data area U and a system area S. The first recording layer La1 has a user data area Ua1 and a system area Sa1. The second recording layer Lb1 has a user data area Ub1 and a system area Sb1. The first recording layer La2 has a user data area Ua2 and a system area Sa2. The second recording layer Lb2 has a user data area Ub2 and a system area Sb2. The first recording layer Lai has a user data area Uai and a system area Sai. The second recording layer Lbi has a user data area Ubi and a system area Sbi.

A track sandwiched between double dashed lines in the figure, in the user data area Ua1 (first recording layer La1), is referred to as a track Ta1. A track located on a side opposite to the track Ta1, in the user data area Ub1 (second recording layer Lb1), is referred to as a track Tb1.

A track sandwiched between double dashed lines in the figure, in the user data area Ua2 (first recording layer La2), is referred to as a track Tc1. A track located on a side opposite to the track Tc1, in the user data area Ub2 (second recording layer Lb2), is referred to as a track Td1.

A track sandwiched between double dashed lines in the figure, in the user data area Uai (first recording layer Lai), is referred to as a track Te1. A track located on a side opposite to the track Te1, in the user data area Ubi (second recording layer Lbi), is referred to as a track Tf1.

In the embodiment, the tracks Ta1, Tb1, Tc1, Td1, Te1, and Tf1 are located on the same cylinder.

The heads HD are opposed to the disks DK. In the embodiment, one head HD is opposed to each recording layer L of the disk DK. For example, the head HD1 is opposed to the first recording layer La1 of the disk DK1, writes the data to the first recording layer La1, and reads the data from the first recording layer La1. The head HD2 is opposed to the second recording layer Lb1 of the disk DK1, writes the data to the second recording layer Lb1, and reads the data from the second recording layer Lb1.

The head HD3 is opposed to the first recording layer La2 of the disk DK2, writes the data to the first recording layer La2, and reads the data from the first recording layer La2. The head HD4 is opposed to the second recording layer Lb2 of the disk DK2, writes the data to the second recording layer Lb2, and reads the data from the second recording layer Lb2. The head HDj-1 is opposed to the first recording layer Lai of the disk DKi, writes the data to the first recording layer Lai, and reads the data from the first recording layer Lai. The head HDj is opposed to the second recording layer Lbi of the disk DKi, writes the data to the second recording layer Lbi, and reads the data from the second recording layer Lbi.

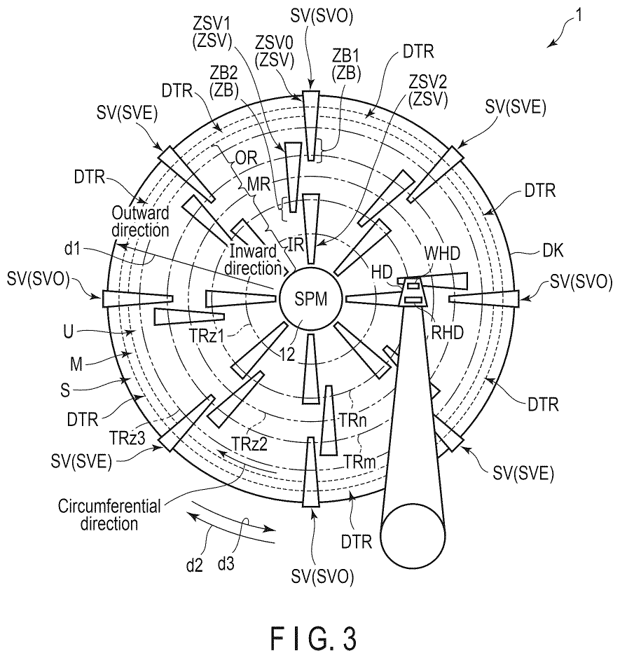

FIG. 3 is a schematic diagram showing an example of arrangement of a plurality of servo areas SV and a plurality of data areas DTR on the single disk DK according to the embodiment. As shown in FIG. 3, a direction toward the outer circumference of the disk DK in the radial direction d1 of the disk DK is referred to as an outward direction (outside), and a direction opposite to the outward direction is referred to as an inward direction (inside).

In FIG. 3, a user data area U is divided into an inner circumferential area IR located in the inward direction, an outer circumferential area OR located in the outward direction, and an intermediate circumferential area MR located between the inner circumferential area IR and the outer circumferential area OR.

The disk DK has a plurality of servo areas SV and a plurality of data areas DTR. For example, the plurality of servo areas SV may extend radially in the radial direction of the disk DK and may be discretely arranged at predetermined intervals in the circumferential direction. For example, the plurality of servo areas SV may extend linearly from the inner circumference to the outer circumference and may be discretely arranged at predetermined intervals in the circumferential direction. For example, the plurality of servo areas SV may extend in a spiral shape from the inner circumference to the outer circumference and may be discretely arranged at predetermined intervals in the circumferential direction. Alternatively, for example, the plurality of servo areas SV may be arranged in a form of islands in the radial direction and may be discretely arranged at different predetermined intervals in the circumferential direction.

In the following descriptions, one servo area SV on a particular track is often referred to as a “servo sector”. Incidentally, the “servo area SV” may be referred to as a “servo sector SV”. The servo sector includes servo data. The “arrangement of several servo data elements constituting the servo sector, and the like” may be hereinafter referred to as a “servo pattern”. Incidentally, the “servo data written in the servo sector” may be often referred to as the “servo sector”.

Each of a plurality of data areas DTR is arranged between a plurality of servo areas SV. For example, the data area DTR corresponds to the area between two continuous servo areas SV in the circumferential direction. One data area DTR on a predetermined track may be hereinafter referred to as the “data sector”. Incidentally, the “data area DTR” may be referred to as a “data sector DTR”. The data sector includes user data. Incidentally, the “user data written to the data sector” may be referred to as the “data sector”. The “data sector” may be referred to as the “user data”. In addition, “a pattern composed of several data elements” may be referred to as a “data pattern”. In the example shown in FIG. 3, the data pattern of a predetermined track is composed of a plurality of servo data elements (servo sectors) and a plurality of user data elements (data sectors).

The servo area SV includes a plurality of zone servo areas ZSV and the like. Incidentally, the servo area SV may include an area including a gap (i.e., a gap between circumferential positions of two zone servo areas), an area including the servo data, the data area DTR, and the like, in addition to the zone servo areas ZSV. The plurality of zone servo areas ZSV are discretely arranged in the radial direction d1. Each of the plurality of zone servo areas ZSV extends in the radial direction d1.

One zone servo area (servo area) ZSV on a predetermined track may be referred to as a “zone servo sector” or a “servo sector”. Incidentally, the “zone servo area (servo area) ZSV” may be referred to as a “zone servo sector ZSV” or a “servo sector ZSV”. The “servo data written to the zone servo sector” may be referred to as a “zone servo sector” or a “servo sector”. The “arrangement of several servo data elements constituting the zone servo sector, and the like” may also be hereinafter referred to as a “zone servo pattern” or a “servo pattern”. One servo area SV on a predetermined track may also be hereinafter referred to as a “zone pattern sector”.

Incidentally, the “servo area SV” may be referred to as the “zone pattern sector”. The “at least one data element and the like written to the zone pattern sector” may be referred to as the “zone pattern sector”. The zone pattern sector includes at least one zone servo sector. The “data pattern of the zone pattern sector” may be hereinafter referred to as a “zone data pattern”.

In the example shown in FIG. 3, the servo areas SV include zone servo areas ZSV0, ZSV1, and ZSV2. The zone servo areas ZSV0, ZSV1, and ZSV2 are arranged in a staggered pattern in the radial direction. The zone servo areas ZSV0, ZSV1, and ZSV2 may be arranged in a staircase pattern in the radial direction.

The zone servo area ZSV2 is located on an inner circumferential side than the zone servo area ZSV1. The zone servo area ZSV0 is located on an outer circumferential side than the zone servo area ZSV1. For example, the zone servo area ZSV2 is arranged to extend from the inner circumferential area IR to the intermediate circumferential area MR, the zone servo area ZSV1 is arranged to extend from the inner circumferential area IR to the outer circumferential area OR, and the zone servo area ZSV0 is arranged to extend from the intermediate circumferential area MR to the outer circumferential area OR. In the following descriptions, a predetermined radial area in which the plurality of zone servo areas ZSV are arranged in the circumferential direction, in a predetermined servo area SV, may be referred to as a zone servo boundary area, double servo area, or double zone servo area ZB.

In the example shown in FIG. 3, the main servo areas SVO and the sub-servo areas SVE are alternately arranged at intervals in the circumferential direction. For example, one sub-servo area SVE is arranged between two main servo areas SVO that are continuously aligned at an interval in the circumferential direction. In other words, one sub-servo area SVE is arranged between two main servo areas SVO that are continuously aligned at an interval in the circumferential direction. For example, when sequentially continuous numbers are assigned to all the servo areas SV of the disk DK, the main servo areas SVO correspond to the odd-numbered servo areas SV, and the sub-servo areas SVE correspond to the even-numbered servo areas SV. Incidentally, two or more sub-servo areas SVE may be arranged between two main servo areas SVO that are continuously arranged at an interval, in the circumferential direction.

The main servo areas SVO and the sub-servo areas SVE may be composed of, for example, only servo areas where the servo data is read and demodulated as a whole (hereinafter often referred to as normal servo areas). In the following descriptions, “reading and demodulating the servo data” may be referred to as “servo-reading”. The main servo areas SVO and the sub-servo areas SVE may be composed of, for example, the normal servo areas, and servo areas (hereinafter often referred to as short servo areas) where servo-reading is executed in a smaller circumferential range of the servo data than a circumferential range of the servo data which is servo-read in the normal servo areas.

A media cache M is allocated to the disk DK. However, the media cache M may not be arranged on the disk DK.

By using the above-described plurality of servo data elements, for example, the positioning error of the head HD (for example, the write head WHD) can be derived.

In the embodiment, it has been described that the number of zones of the disk DK is three, but the number of zones of the disk DK can be variously changed. The number of zones of the disk DK may be thirty to forty. In addition, each zone includes a plurality of bands. For example, each zone includes several hundreds of bands.

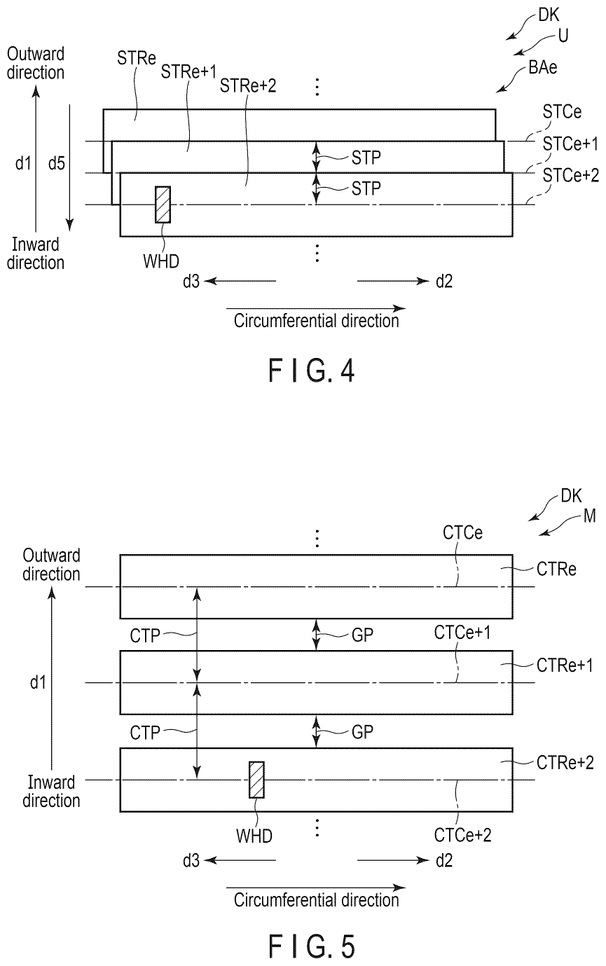

FIG. 4 is a schematic diagram showing three tracks STR of the user data area U where the shingled magnetic recording processing is executed for the disk DK shown in FIG. 3, and the write head WHD. The user data area U is a shingled magnetic recording area. Sequentially writing the data in band units in the user data area U is permitted, i.e., shingled magnetic recording is permitted.

As shown in FIG. 4, the write head WHD can sequentially write the data to the disk DK in the traveling direction d2. The read head RHD shown in FIG. 3 can also sequentially read the data written to the disk DK in the traveling direction d2.

In the direction parallel to the radial direction d1, the direction of sequentially executing the shingled magnetic recording for a plurality of tracks STR that are a plurality of data tracks, i.e., the direction of making a track STR to which the data is be next written overlap with a track STR to which the data has been previously written, in the radial direction d1, is referred to as an overwrite direction or a recording progress direction. In a band BAe shown in FIG. 4, an overwrite direction d5 is an inward direction, but the overwrite direction may be an outward direction.

For example, an overwrite direction applied to a plurality of bands BA (a plurality of zones Z) located on an outer circumference side than a specific radial position and an overwrite direction applied to a plurality of bands BA (a plurality of zones Z) located on an inner circumferential side than the specific radial position may be opposite to each other.

The band BAe includes a plurality of tracks STR including tracks STRe, STRe+1, and STRe+2. The tracks STRe, STRe+1, and STRe+2 are sequentially overwritten in the overwrite direction d5 in the order described above. The track STRe among the tracks STRe, STRe+1, and STRe+2 corresponds to the track where data is first written, and the track STRe+2 corresponds to the track where data is last written.

The track STRe has a track center STCe at the center of the radial direction d1 when no other tracks are overwritten. The track STRe+1 has a track center STCe+1 at the center of the radial direction d1 when no other tracks are overwritten. The track STRe+2 has a track center STCe+2 at the center of the radial direction d1 when no other tracks are overwritten.

In the example shown in FIG. 4, the data is written to the tracks STRe, STRe+1, and STRe+2 at a pitch (shingled magnetic recording track pitch) STP. The track center STCe of the track STRe and the track center STCe+1 of the track STRe+1 are separated from each other at a pitch STP in the radial direction d1. The track center STCe+1 of the track STRe+1 and the track center STCe+2 of the track STRe+2 are separated from each other at a pitch STP in the radial direction d1. The data may be written to the tracks STRe to STRe+2 at different pitches.

A width in the radial direction d1 of the area of the track STRe where the track STRe+1 is not overwritten and a width in the radial direction d1 of the area of the track STRe+1 where the track STRe+2 is not overwritten are the same as each other. Incidentally, the width in the radial direction d1 of the area of the track STRe where the track STRe+1 is not overwritten and the width in the radial direction d1 of the area of the track STRe+1 where the track STRe+2 is not overwritten may be different from each other.

In FIG. 4, each track STR has a rectangular shape for convenience of descriptions but, in reality, each track STR is curved along the circumferential direction. In addition, each track STR may have a wave shape extending in the circumferential direction while varying in the radial direction d1. Incidentally, three tracks STR are overwritten in FIG. 4, but two tracks STR may be overwritten or more three tracks STR may be overwritten.

The write processing unit 62 can select the shingled magnetic recording system of overwriting the data on a plurality of tracks STR in the overwrite direction d5 and cause the write head WHD to write the data to each of the bands BA. In the example shown in FIG. 4, the write processing unit 62 sequentially executes the shingled magnetic recording of the tracks STRe to STRe+2 in the band BAe at the pitch STP in the inward direction (overwrite direction d5). Since the user data area U is the area where the data is written in the shingled magnetic recording, the recording density of the user data area U can be improved.

The write processing unit 62 writes the data to the track STRe+1 at the pitch STP in the inward direction of the track STRe and overwrites the track STRe+1 on an inner circumferential part of the track STRe. The write processing unit 62 writes the data to the track STRe+2 at the pitch STP in the inward direction of the track STRe+1 and overwrites the track STRe+2 on an inner circumferential part of the track STRe+1.

FIG. 5 is a schematic diagram showing three tracks CTR of the media cache M where the conventional magnetic recording processing of the disk DK shown in FIG. 3 is executed, and the write head WHD. The media cache M and the system area S shown in FIG. 3 are the conventional magnetic recording areas. In the media cache M and the system area S, randomly writing the data is permitted, i.e., conventional magnetic recording is permitted.

As shown in FIG. 5, the media cache M includes a plurality of tracks CTR including tracks CTRe, CTRe+1, and CTRe+2. Each of a plurality of tracks CTR is a data track. For example, widths (track widths) in the radial direction d1 of the tracks CTRe, CTRe+1, and CTRe+2 are the same as each other. Incidentally, the track widths of the tracks CTRe to CTRe+2 may be different from each other.

The track CTRe has a track center CTCe at the center of the radial direction d1, the track CTRe+1 has a track center CTCe+1 at the center of the radial direction d1, and the track CTRe+2 has a track center CTCe+2 at the center of the radial direction d1. In the example shown in FIG. 5, the tracks CTRe, CTRe+1, and CTRe+2 are written at the pitch (conventional magnetic recording track pitch) CTP. The track center CTCe of the track CTRe and the track center CTCe+1 of the track CTRe+1 are separated from each other at the pitch CTP. The track center CTCe+1 of the track CTRe+1 and the track center CTCe+2 of the track CTRe+2 are separated from each other at the pitch CTP.

The track CTRe and the track CTRe+1 are separated from each other at a gap GP. The track CTRe+1 and the track CTRe+2 are separated from each other at the gap GP. Incidentally, the data may be written to the tracks CTRe to CTRe+2 at different pitches. In FIG. 5, each track CTR has a rectangular shape for convenience of descriptions but, in reality, each track CTR is curved along the circumferential direction. In addition, each track CTR may have a wave shape extending in the circumferential direction while varying in the radial direction d1.

The write processing unit 62 can execute the write processing by selecting the conventional magnetic recording of writing the data to a plurality of tracks CTR spaced apart in the radial direction d1 of the disk DK. In the example shown in FIG. 5, the write processing unit 62 positions the write head WHD at the track center CTCe in a predetermined area of the disk DK and executes the conventional magnetic recording in a predetermined sector of the track CTRe or the track CTRe.

The write processing unit 62 positions the write head WHD at the track center CTCe+1, which is separated from the track center CTCe of the track CTRe in the inward direction by the pitch CTP, and executes the conventional magnetic recording in a predetermined sector of the track CTRe+1 or the track CTRe+1. The write processing unit 62 positions the write head WHD at the track center CTCe+2, which is separated from the track center CTCe+1 of the track CTRe+1 in the inward direction by the pitch CTP, and executes the conventional magnetic recording in a predetermined sector of the track CTRe+2 or the track CTRe+2.

The write processing unit 62 may sequentially execute the conventional magnetic recording in the tracks CTRe, CTRe+1, and CTRe+2, in a predetermined area of the disk DK, or randomly execute the conventional magnetic recording in a predetermined sector of the track CTRe, a predetermined sector of the track CTRe+1, and a predetermined sector of the track CTRe+2.

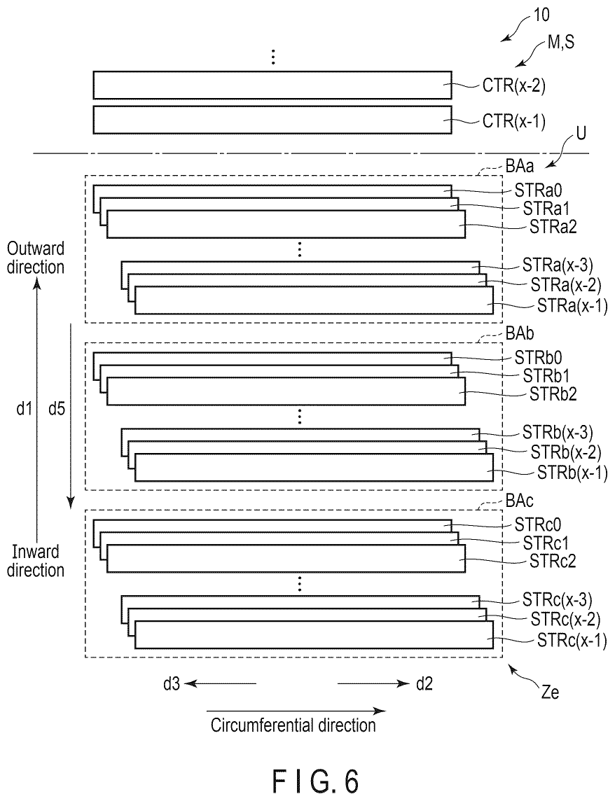

FIG. 6 is a schematic diagram showing an example of the data write processing on the disk DK. Each of the tracks STR and CTR is a data track. As shown in FIG. 6, the user data area U includes bands BAa, BAb, and BAc. The bands BAa, BAb, and BAc belong to the same zone Ze. In the zone Ze, the bands BAa, BAb, and BAc are intermittently arranged in the overwrite direction in the order of these descriptions.

The bands BAa and BAb are adjacent to each other in the radial direction d1, and the bands BAb and BAc are adjacent to each other in the radial direction d1.

The band BAa includes x tracks such as tracks STRa0, STRa1, STRa2, . . . , STRa(x−3), STRa(x−2), and STRa(x−1). The tracks STRa0 to STRa(x−1) are subjected to the shingled magnetic recording in the overwrite direction d5 in the order of these descriptions. In the band BAa, the track STRa0 corresponds to a first track where the data is first written, and the track STRa(x−1) corresponds to the last track where the data is last written.

The band BAb includes x tracks such as tracks STRb0, STRb1, STRb2, . . . , STRb(x−3), STRb(x−2), and STRb(x−1). The tracks STRb0 to STRb(x−1) are subjected to the shingled magnetic recording in the overwrite direction d5 in the order of these descriptions. In the band BAb, the track STRb0 corresponds to a first track where the data is first written, and the track STRb(x−1) corresponds to the last track where the data is last written.

The band BAc includes x tracks such as tracks STRc0, STRc1, STRc2, . . . , STRc(x−3), STRc(x−2), and STRc(x−1). The tracks STRc0 to STRc(x−1) are subjected to the shingled magnetic recording in the overwrite direction d5 in the order of these descriptions. In the band BAc, the track STRc0 corresponds to a first track where the data is first written, and the track STRc(x−1) corresponds to the last track where the data is last written.

The number of the tracks STR included in each of the bands BA belonging to the same zone Z is the same. For example, the number of the tracks STR included in each of the bands BA belonging to the zone Ze is the same. In other words, the number of the tracks STR included in the band BA is fixed for each zone Z. In this example, the number of tracks STR in each of the bands BA belonging to the zone Ze is x.

FIG. 6 shows tracks CTR(x−2) and CTR(x−1). In FIG. 6, the tracks CTR(x−2) and CTR(x−1) are subjected to the conventional magnetic recording in the media cache M or the system area S. The tracks CTR(x−2) and CTR(x−1) are adjacent to each other in the radial direction d1.

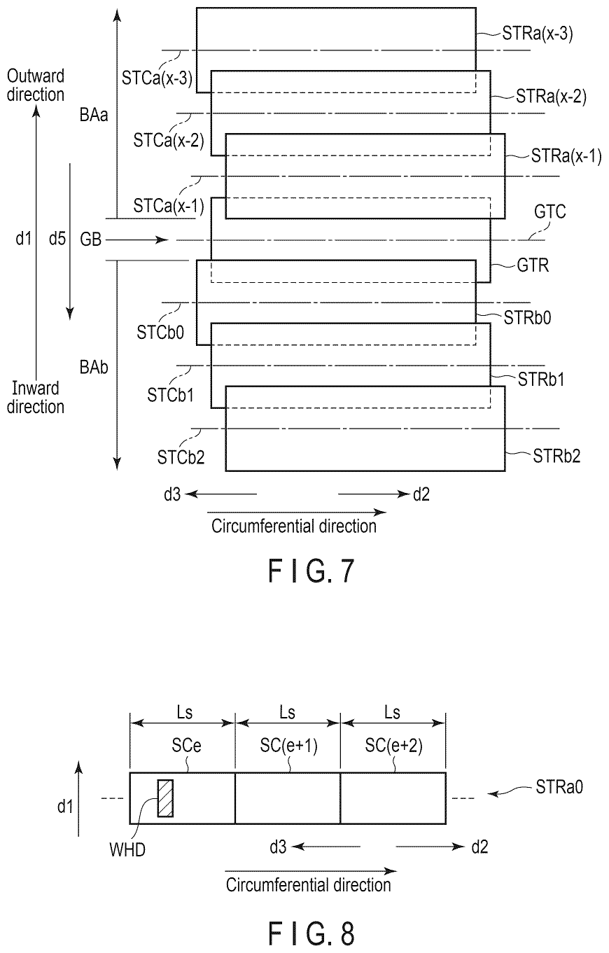

FIG. 7 is a schematic diagram showing two bands BAa and BAb and one guard band GB of the user data area U shown in FIG. 6. As shown in FIG. 7, in the shingled magnetic recording, unlike the conventional magnetic recording, the MPU 60 manages a track group of the user data area U in units referred to as bands, with the feature of overwriting the data to a part of the track STR.

A guard band GB is generally provided between adjacent bands BA in the radial direction d1. The guard band GB includes a guard track GTR. Unlike the embodiment, the guard band GB may include a plurality of guard tracks GTR. The guard band GB has a role of suppressing the interference between the adjacent bands BA. The shingled magnetic recording can be executed in a unit of one band BA by the guard band GB. In addition, the ranges (bands BA) where the data is sequentially written can be separated by the guard band GB.

For example, the track center STCa(x−3) of the track STRa(x−3), the track center STCa(x−2) of the track STRa(x−2), the track center STCa(x−1) of the track STRa(x−1), the track center GTC of the guard track GTR, the track center STCb0 of the track STRb0, the track center STCb1 of the track STRb1, and the track center STCb2 of the track STRb2, are located at equal pitch in the overwrite direction d5.

The recording capacity of each band BA in the user data area U is usually predetermined based on the specifications required by the user except for the guard band GB. The MPU 60 can record the same capacity of data in each of the bands BA. In general, the recording capacity of each band BA is 128 MiB or 256 MiB.

FIG. 8 is a schematic diagram showing three sectors SCe, SC(e+1), and SC(e+2) of one track STRa0 of the band BAa shown in FIG. 6. As shown in FIG. 8, each track STR includes a plurality of sectors SC. The track STRa1 includes a plurality of sectors SC including sectors SCe, SC(e+1), and SC(e+2).

If the sector SC(e+1) is the n-th sector among the plurality of sectors SC of the track STRa0, then the sector SC(e+2) is the n+1-th sector following the sector SC(e+1) in the traveling direction d2, and the sector SCe is the n−1-th sector located in front of the sector SC(e+1) in the traveling direction d2. The number of the sectors SC included in each of the tracks STR belonging to the same zone Z is the same. In the embodiment, the number of sectors SC included in each of the tracks STR belonging to the zone Ze is y.

Each of the sectors SC has a length Ls in the circumferential direction of the disk DK. Each sector SC may be a split sector that is divided by the servo sector SV. In this case, the length of the sector SC does not need to be Ls.

The write head WHD is a magnetic head for energy-assisted recording that executes energy assisted magnetic recording (EAMR). In the embodiment, the write head WHD is configured to use energy other than the magnetic energy, but the write head WHD may also be a magnetic head that is not configured to execute the energy assisted magnetic recording.

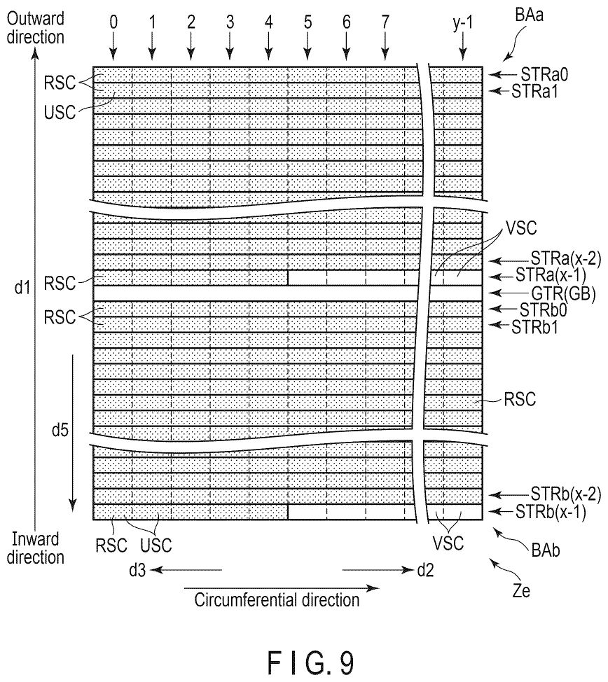

FIG. 9 is a schematic diagram showing the two bands BAa and BAb and one guard band GB shown in FIG. 7, illustrating the plurality of target sectors RSC and the plurality of unused sectors VSC.

In FIG. 9, each track STR has a rectangular shape for convenience of description but, in reality, each track STR is curved along the circumferential direction. In addition, a plurality of tracks STR are aligned in the overwrite direction d5 without overlapping but, in reality, the plurality of tracks STR are aligned in the overwrite direction d5 while overlapping. In the figure, the target sector RSC is marked with a dot pattern. Unused sectors VSC are represented by a solid color.

As shown in FIG. 9, the band number of the band BAa is “a” and the band number of the band BAb is “b”. The track numbers of the respective bands BA are set to “0” to “x−1”. The sector numbers of the respective tracks STR are set to “0” to “y−1”. In the following descriptions, the sector SC of each band BA may be identified by the following code “SC (track number or sector number)”.

In the embodiment, the band BAa is a band adjacent to a band BAb, and is a band located above the band BAb in the overwrite direction d5.

Each track STR of the band BAa includes G target sectors RSC (one or more target sectors RSC) on which valid data is written. For example, the track STRa0 includes y target sectors RSC (G=y). All the sectors SC of the track STRa0 are the target sectors RSC. The track STRa(x−1) includes five target sectors RSC (G=5). The remaining sectors SC of the track STRa(x−1) are unused sectors VSC where valid data is not written.

Based on the above, the number of target sectors RSC on the track STRa0 is different from the number of target sectors RSC on the track STRa(x−1).

In each of the bands BA of the zone Ze, all the sectors SC of x−1 tracks STR from number 0 to number x−2 are the target sectors RSC where valid data is written, and are the recorded sectors USC. On the x−1-th track STR of each band BA of the zone Ze, five sectors SC from number 0 to number 4 are the target sectors RSC, and are the recorded sectors USC. In contrast, on the x−1-th track STR, remaining sectors SC from number 5 to number y−1 are the unused sectors VSC where valid data is not written.

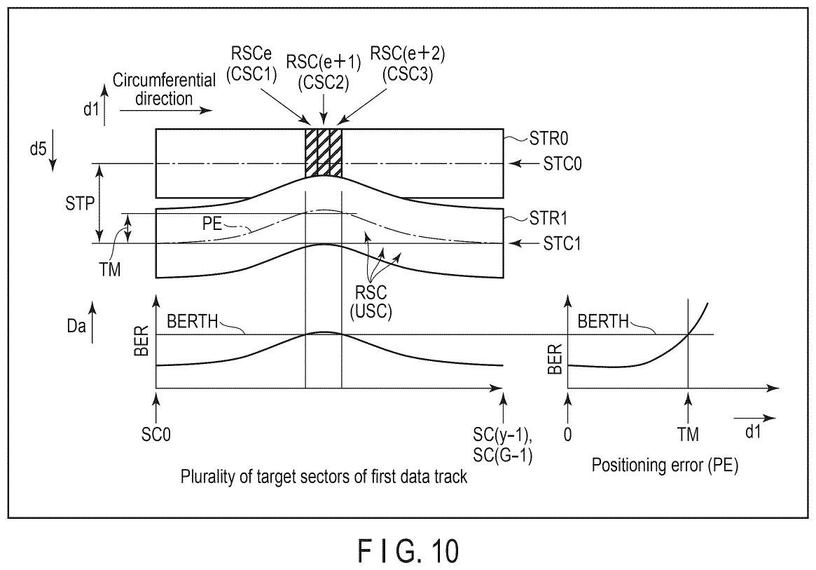

FIG. 10 is a schematic diagram showing an example of the first track STR0 and the second track STR1 in a case where it is assumed that the magnetic disk device 1 does not comprise a function of executing the error correction of the data on the track TR, illustrating the write processing for the first track STR0 and the second track STR1, illustrating a state in which the write processing for the second track STR1 is continued until the error correction in each sector for the first track STR0 reaches its limit, and illustrating each of the change in a bit error rate (BER) for the first track STR0 and the change in BER for the positioning error PE in graph form. In the descriptions made with reference to FIG. 10, it is assumed that the magnetic disk device 1 does not comprise the error correction unit 64 shown in FIG. 1. In addition, in FIG. 10 as well, the first track STR0 and the like are drawn by assuming the circumferential direction to be linear, for convenience of descriptions.

As shown in FIG. 10, in the recording layer L, the plurality of tracks STR are adjacent in the radial direction d1. The first track STR0 and the second track STR1 are the data tracks adjacent to each other, and all sectors SC of the first track STR0 and all sectors (data sectors) SC of the second track STR1 are the target sectors RSC. The write processing for the first track STR0 is executed ideally without any positioning error PE (PE≈0 or PE=0).

If the magnetic disk device 1 is affected by external vibration or the like during the write processing, a positioning error PE occurs when positioning the write head WHD. The positioning error PE is the amount of deviation from the target position of the write head WHD in the radial direction d1. By setting a track margin TM, the allowable range in which it is guaranteed that data on adjacent tracks can be read can be determined.

For example, if the write processing is executed on the second track STR1 and if the target sectors RSCe, RSC(e+1), and RSC(e+2) of the first track STR0 are adjacent to the write head WHD in the radial direction d1 during the period when the positioning error PE exceeds the track margin TM, it is determined (predicted) that the data in the target sectors RSCe, RSC(e+1), and RSC(e+2) of the first track STR0 are corrupted. Although a lower BER of the data is desirable, the BER of the data of the target sectors RSCe, RSC(e+1), and RSC(e+2) of the first track STR0 exceeds a threshold value BERTH. Incidentally, as understood from the graph on the right side of FIG. 10, as the positioning error PE becomes greater, the adverse effect of adjacent track interference (ATI) becomes greater and the BER of the data on the first track STR0, which is adversely affected by ATI, becomes excessively high.

For this reason, the target sectors RSCe, RSC(e+1), and RSC(e+2) among the plurality of target sectors RSC of the first track STR0 are determined to be corrupted target sectors CSC1, CSC2, and CSC3, respectively. This matter may lead to situations where the quality of the signals obtained by reading the data in the corrupted target sectors CSC1, CSC2, and CSC3 are deteriorated or the data in the corrupted target sectors CSC1, CSC2, and CSC3 is erased.

In the example described with reference to FIG. 10, the magnetic disk device 1 does not comprise a function of executing track-based error correction for the data on the track TR. In this case, track-based error correction is also referred to as track-based error correction, track error correction code (ECC), or the like. For this reason, the target sectors RSCe, RSC(e+1), and RSC(e+2) remain the corrupted target sectors CSC1, CSC2, and CSC3, respectively.

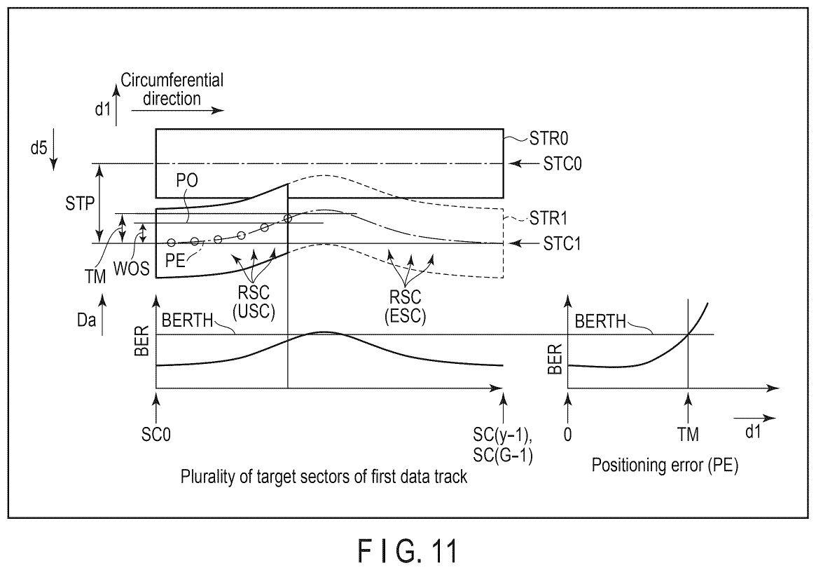

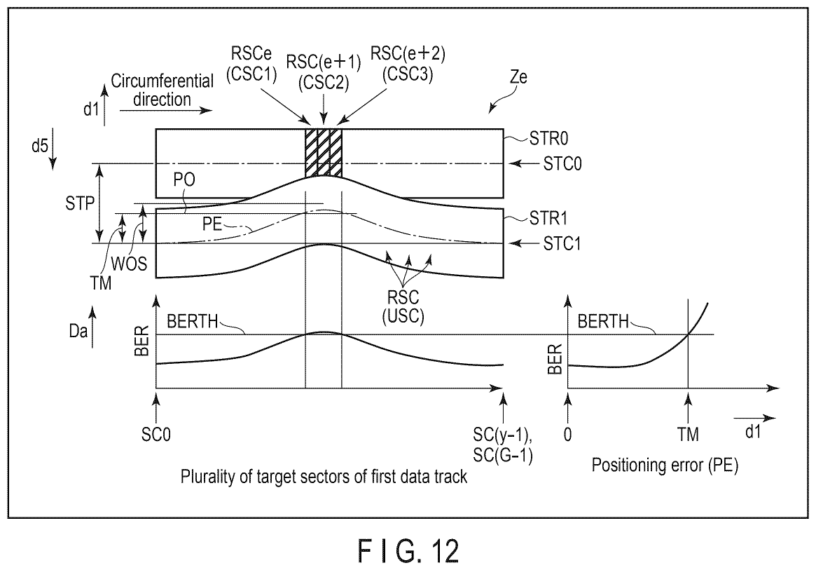

In FIG. 10, it has been described that all the target sectors RSC of the track TR have a common track margin TM. In the following descriptions of FIG. 11 and FIG. 12 as well, it will be explained that all the target sectors RSC of the track TR have a common track margin TM. However, the above-described setting of the track margin TM is just an example, and the track margin TM may be different for each target sector RSC.

FIG. 11 is a schematic diagram showing an example of the first track STR0 and the second track STR1 in a case where it is assumed that the magnetic disk device 1 does not comprise a function of executing the track-based error correction for the data of the track TR, illustrating the write processing for the first track STR0 and the second track STR1, illustrating a state in which the write processing for the second track STR1 is ended when a determination value is set to a write-off track slice WOS smaller (more severe) than the track margin TM and it is detected that the positioning error PE exceeds a reference radius position PO, and illustrating each of the change in BER for the first track STR0 and the change in BER for the positioning error PE in graph form. In FIG. 11 as well, the first track STR0 and the like are drawn by assuming the circumferential direction to be linear, for convenience of descriptions. In the descriptions made with reference to FIG. 11, it is assumed that the magnetic disk device 1 does not comprise the error correction unit 64 shown in FIG. 1.

As shown in FIG. 11, the first track STR0 and the second track STR1 are the data tracks, and all the sectors SC of the first track STR0 and all the sectors (data sectors) SC of the second track STR1 are the target sectors RSC. The write processing for the first track STR0 is executed ideally without any positioning error PE (PE≈0 or PE=0). The first track STR0 is located in the first direction Da that is parallel to the radial direction d1 as seen from the second track STR1.

The write processing unit 62 can select the shingled magnetic recording of making the data of the second track STR1 overlap with the data of the first track STR0 in the overwrite direction d5 opposite to the first direction Da and writing the data.

In order to prevent or suppress the write processing in a state where the positioning error PE exceeds the track margin TM, the magnetic disk device 1 has a write-off track slice WOS. The reference radius position PO is a position offset by the write-off track slice WOS in the first direction Da from a track center STC1 of the second track STR1. When it is determined that the positioning error PE has exceeded the reference radius position PO during the period when the data is being written to the second track STR1, writing the data to the second track STR1 can be suspended. The remaining target sectors RSC for which data writing has been postponed, among the plurality of target sectors RSC of the second track STR1, become empty sectors ESC where no data is written. The occurrence of the corrupted target sectors CSC on the first track STR0 can be prevented by avoiding the situation in which the positioning error PE exceeds the track margin TM.

Incidentally, the track STR has a servo sector in addition to the sector SC that is the data sector. In the track STR, data sectors and servo sectors are generally arranged alternately. The head HD (read head RHD) can derive the positioning error PE together with the servo sector. Therefore, the positioning error PE is generally information which can be obtained intermittently.

In order to prevent PE from becoming greater than TM, the write-off track slice WOS needs to be set such that WOS≤TM. In order to avoid the situation where PE becomes greater than TM, it is desirable to set the write-off track slice WOS such that WOS<TM. Thus, the write processing for the second track STR1 can be suspended before the positioning error PE exceeds the track margin TM, and the situation in which the quality of the data on the first track STR0 is deteriorated can be avoided.

However, it needs to be noted that the write processing can be suspended more easily as the write-off track slice WOS is set to be smaller, which leads to a decrease in the write performance of the magnetic disk device 1. Incidentally, if the write processing for the second track STR1 is suspended, in the magnetic disk device 1 that does not comprise the function of executing the track-based error correction, write retry processing of resuming the write processing for the second track STR1 after awaiting the rotation of the disk DK until PE≤WOS, is resumed. Since the empty sector ESC of the second track STR1 can be changed to a recorded sector USC, in the write retry processing, the situation in which the utilization efficiency of the second track STR1 remains low is avoided.

In FIG. 11, it has been described that all the target sectors RSC of the track TR have a common write-off track slice WOS. In the following descriptions of FIG. 12 as well, it will be described that all the target sectors RSC of the track TR have a common write-off track slice WOS. However, the above-described setting of the write-off track slice WOS is an example, and the write-off track slice WOS may be different for each target sector RSC.

FIG. 12 is a schematic diagram showing an example of the first track STR0 and the second track STR1 of the magnetic disk device 1 that comprises a function of executing the track-based error correction for the data of the track TR, illustrating the write processing for the first track STR0 and the second track STR1, illustrating a state in which a determination value is set to the write-off track slice WOS greater (more loose) than the track margin TM and the write processing for the second track STR1 is continued until the track-based error correction for the first track STR0 reaches a limit, and illustrating each of the change in BER for the first track STR0 and the change in BER for the positioning error PE in graph form. In FIG. 12 as well, the first track STR0 and the like are drawn by assuming the circumferential direction to be linear, for convenience of descriptions.

As shown in FIG. 12, the write processing for the first track STR0 is executed ideally without any positioning error PE (PE≈0 or PE=0).

The magnetic disk device 1 comprises an error correction unit 64. When a corrupted target sector CSC occurs in the track ST, the read processing unit 63 can detect, together with the head amplifier IC 130, that a corrupted target sector CSC has occurred in the track ST, and the error correction unit 64 can execute the error correction processing to recover the data of the corrupted target sector CSC. For example, if a corrupted target sector CSC occurs in the first track STR0, the error correction unit 64 can recover the data of the corrupted target sector CSC, based on the parity of the parity sector and the user data of the plurality of elements of the target sectors RSC on the first track STR0.

The above parity sector is generated based on the user data of the plurality of elements of target sectors RSC of the first track STR0, and can be provided in part of the plurality of target sectors RSC of the first track STR0. For example, one or two target sectors RSC of the first track STR0 can be used as the parity sector or sectors. However, the above parity sectors may be provided in tracks TR other than the first track STR0. Alternatively, the above parity sectors may be provided in the memory other than the disk (for example, nonvolatile memory 90).

As described above, even if a corrupted target sector CSC occurs in the first track STR0, the error correction unit 64 can execute the error correction processing to recover the data of the corrupted target sector CSC. The occurrence of the corrupted target sector CSC in the first track STR0 can be therefore allowed. In the magnetic disk device 1 comprising the error correction unit 64, the write-off track slice WOS can be set such that WOS≥TM.

Incidentally, it needs to be noted that there is an upper limit for the number of corrupted target sectors for which the error correction unit 64 can execute the track-based error correction, in units of tracks TR. For example, if the number of corrupted target sectors CSC in the first track STR0 exceeds the upper limit (for example, 12), it is difficult for the error correction unit 64 to recover the data of all the corrupted target sectors CSC.

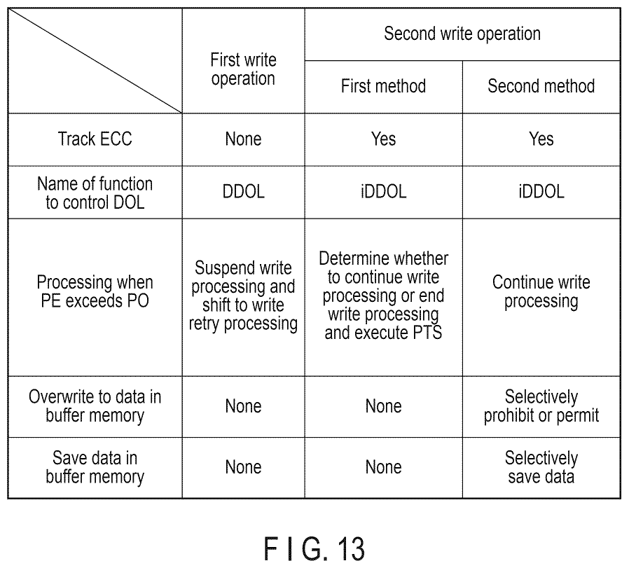

FIG. 13 is a table showing the presence or absence of a track ECC, the name of the function that controls DOL, the contents of the processing in a case where the positioning error PE exceeds the reference radius position PO, settings on overwriting to the data in the buffer memory 80, and settings on saving the data in the buffer memory 80, in the first and second methods of the first and second write operations.

As shown in FIG. 13, FIG. 11, and FIG. 1, when it is assumed that the magnetic disk device 1 does not comprise the function of the track ECC, the magnetic disk device 1 can adopt the first write operation. The name of the function of controlling Drift-Off Level (DOL) is Dynamic Drift-Off Level (DDOL). The first write operation corresponds to the write operation disclosed with reference to FIG. 11.

If the positioning error PE exceeds the reference radius position PO during the first write period during which the write processing for the second track STR1 is being executed, the write processing for the second track STR1 is suspended before the positioning error PE exceeds the track margin TM. After that, the write retry processing of resuming the write processing for the second track STR1 after waiting for the disk DK to rotate until PE≤WOS is executed.

Incidentally, if the magnetic disk device 1 adopts the first write operation, the write retry processing such as the disk DK rotation wait operation, may occur frequently. As a result, it is difficult to improve the write performance of the magnetic disk device 1. Therefore, in order to improve the write performance of the magnetic disk device 1, the magnetic disk device 1 that adopts the second write operation comprises the function of the track ECC. In the magnetic disk device 1 that adopts the second write operation, the name of the function of controlling the DOL is intelligence Dynamic Drift-Off Level (iDDOL).

It is possible to allow a certain number of corrupted target sectors CSC to occur in the track STR, and it is possible to improve Track Per Inch (TPI).

### Second Method of the Second Write Operation

Next, the second method of the second write operation will be described.

As shown in FIG. 13, FIG. 1, and FIG. 12, the error correction unit 64 can execute the error correction of the data in one or more corrupted target sectors CSC in which the data is considered to be corrupted, among the plurality of target sectors RSC of the first track STR0.

The buffer memory 80 can hold a plurality of elements of data including the first user data and the second user data.

The management unit 65 can selectively execute first management of prohibiting overwrite to first user data in the buffer memory 80, second management of permitting overwrite to all elements of the first user data in the buffer memory 80, and third management of permitting overwrite to data belonging to a first group and a second group among the first user data in the buffer memory 80 and prohibiting overwrite to data belonging to a third group among the first user data in the buffer memory 80.

The first write period, i.e., the period elapsed after the write processing unit 62 has executed the write processing of writing the first data including the first user data to the plurality of target sectors RSC of the first track STR0, and the period in which the write processing unit 62 executes the write processing of writing second data including second user data to the plurality of target sectors RSC of the second track STR1, is focused.

During the first write period, the read processing unit 63 executes the seek processing of causing the read head RHD to seek and makes the write head WHD face the second track STR1.

Each time the data is written to each target sector RSC of the second track STR1, the correction limit discrimination unit 66 obtains information that the position of the write head WHD is displaced beyond the reference radius position PO in the first direction Da.

The management unit 65 executes the above-described first management.

If determining that the error correction of the first user data on the first track STR0, which is executed by the error correction unit 64, does not exceed the limit, based on the information obtained by the correction limit discrimination unit 66, the determination unit 67 can cause the write processing unit 62 to continue the write processing for the second track STR1 and cause the management unit 65 to execute the second management instead of the first management.

Since the first user data does not need to be held in the buffer memory 80, overwriting data to the first user data in the buffer memory 80 can be allowed and the amount of the data that can be newly received by the buffer memory 80 can be increased.

In addition, if determining that the error correction of the first user data on the first track STR0, which is executed by the error correction unit 64, has exceeded the limit, based on the above-described information, the determination unit 67 can cause the write processing unit 62 to continue the write processing for the second track STR1 and cause the management unit 65 to execute the third management instead of the first management.

Then, during the first write period or after the first write period, the determination unit 67 can cause the management unit 65 to save the data belonging to the third group to, for example, the system area S of the recording layer L of the disk DK serving as a nonvolatile recording medium. The data saved to the system area S can be permanently stored in the system area S.

Incidentally, the data belonging to the first group among the first user data in the buffer memory 80 is original data of the data of one or more target sectors RSC in which the data is determined to be uncorrupted, among a plurality of target sectors RSC of the first track STR0.

The data belonging to the second group among the first user data in the buffer memory 80 is original data of the data of one or more first corrupted target sectors CSC in which the data is determined to be corrupted, among the plurality of target sectors RSC of the first track STR0, and original data of the data within a range of being subjected to the error correction executed by the error correction unit 64.

The data belonging to the third group among the first user data in the buffer memory 80 is original data of the data of one or more second corrupted target sectors CSC in which the data is determined to be corrupted, among the plurality of target sectors RSC of the first track STR0, and original data of the data which leaks from the range of being subjected to the error correction executed by the error correction unit 64.

Even if the error correction executed by the error correction unit 64 exceeds the limit, the write processing for the second track STR1 can be continued. The degradation in write performance can be therefore suppressed.

Furthermore, as regards the excessive corrupted data for which error correction executed by the error correction unit 64 exceeds the limit, among the corrupted data of the first track STR0, the original data of the excessive corrupted data can be saved from the buffer memory 80 to the system area S. The excessive corrupted data on the first track STR0 can be ensured indirectly. The error correction unit 64 can execute the error correction processing of recovering the data of all the corrupted target sectors CSC of the first track STR0, using the first user data and the first parity on the first track STR0, and the original data saved to the system area S. A situation in which the quality of the signal obtained by reading the data of the first track STR0 remains deteriorated can be avoided so as to improve the quality of the data of the first track STR0.

In contrast, if the first method of the second write operation is adopted, the situation in which the error correction executed by the error correction unit 64 exceeds the limit cannot be allowed. There is a risk that the frequency of suspending (or ending) the write processing for the second track STR1 may be increased. Incidentally, when the write processing is ended, the frequency of activating Partial Track Slip (PTS) saving the remaining data that could not be written to the second track STR1, may be increased. The first method of the second write operation can hardly contribute to improvement of the write performance of the magnetic disk device 1.

Next, the first track STR0 and the second track STR1 after ending the write processing for the first track STR0 and the second track STR1 by adopting the second method of the second write operation are focused.

The first user data is written to all the target sectors RSC of the first track STR0. Alternatively, both the first user data and the first parity generated based on the first user data are written to all the target sectors RSC of the first track STR0.

The second user data is written to all the target sectors RSC of the second track STR1. Alternatively, both the second user data and the second parity generated based on the second user data are written to all the target sectors RSC of the second track STR1.

Since no activation of PTS is executed in the second method of the second write operation, the target sectors RSC of the first track STR0 and the second track STR1 cannot be empty sectors ESC. The efficiency of use of the first track STR0 and the second track STR1 can be therefore increased.

Next, a case in which the information obtained by the correction limit discrimination unit 66 is the cumulative actual excess amount, i.e., the cumulative total of the actual excess amount at which the positioning error PE is displaced beyond the reference radius position PO in the first direction Da will be described.

Each time the second data is written to each target sector RSC of the second track STR1, the correction limit discrimination unit 66 can measure the actual excess amount of the position of the write head WHD, which is displaced beyond the reference radius position PO in the first direction Da, and update the cumulative actual excess amount, which is the cumulative total of the actual excess amount. The above-described information obtained by the correction limit discrimination unit 66 is the cumulative actual excess amount.

During the first write period, if determining that the cumulative actual excess amount is smaller than or equal to the upper limit threshold value, the determination unit 67 can cause the write processing unit 62 to continue the write processing for the second track STR1 and cause the management unit 65 to execute the second management instead of the first management. In this example, the upper limit threshold value is a value indicating the limit of a range in which the error correction for the first track STR0 can be executed.

During the first write period, if determining that the cumulative actual excess amount has exceeded the upper limit threshold value, the determination unit 67 can cause the write processing unit 62 to continue the write processing for the second track STR1, cause the management unit 65 to execute the third management instead of the first management, and cause the correction limit discrimination unit 66 to temporarily update the cumulative actual excess amount obtained by subtracting from the cumulative actual excess amount the actual excess amount measured each time the one or more second corrupted target sectors CSC are formed on the first track STR0.

The determination unit 67 can determine whether to permit or prohibit overwriting to the original data in the buffer memory 80 and whether the original data needs to be saved from the buffer memory 80 to the system area S, based on a relationship between the cumulative actual excess amount and the upper limit threshold value.

When the determination unit 67 saves the original data from the buffer memory 80 to the system area S, it is desirable to save the original data of the most corrupted data on the first track STR0 in priority. This is because the cumulative actual excess amount can be updated to the smallest amount such that the cumulative actual excess amount can hardly exceed the upper limit threshold value.

In this case, the second actual excess amount is more than or equal to a first actual excess amount. Each actual excess amount in a case where one or more first corrupted target sectors CSC are formed on the first track STR0 is the first actual excess amount. In addition, each actual excess amount in a case where one or more second corrupted target sectors CSC are formed on the first track STR0 is the second actual excess amount.

Next, a case where the information obtained by the correction limit discrimination unit 66 is the cumulative number, i.e., the cumulative count of the numbers of the corrupted target sectors CSC will be described.

The correction limit discrimination unit 66 can count the number of one or more corrupted target sectors CSC on the first track STR0 and update the cumulative number that is the above-described cumulative count. The information obtained by the correction limit discrimination unit 66 is the cumulative number.

During the first write period, if determining that the cumulative number is smaller than or equal to the upper limit number, the determination unit 67 can cause the write processing unit 62 to continue the write processing for the second track STR1 and cause the management unit 65 to execute the second management instead of the first management. In this example, the upper limit number is the number indicating the limit of a range in which the error correction for the first track STR0 can be executed.

During the first write period, if determining that the cumulative number has exceeded the upper limit number, the determination unit 67 can cause the write processing unit 62 to continue the write processing for the second track STR1, cause the management unit 65 to execute the third management instead of the first management, and cause the correction limit discrimination unit 66 to temporarily update the cumulative number obtained by subtracting from the cumulative number the number of the second corrupted sectors CSC counted each time the one or more second corrupted target sectors CSC are formed on the first track STR0.

Incidentally, if the cumulative number exceeds the upper limit number, the total number of one or more first corrupted target sectors CSC matches the upper limit number.

The determination unit 67 can determine whether to permit or prohibit overwriting to the original data in the buffer memory 80 and whether the original data needs to be saved from the buffer memory 80 to the system area S, based on a relationship between the cumulative number and the upper limit number.

Next, a case where the information obtained by the correction limit discrimination unit 66 is both the cumulative actual excess amount and the cumulative number will be described.

During the first write period, if determining that the cumulative actual excess amount is smaller than or equal to the upper limit threshold value and if determining that the cumulative number is smaller than or equal to the upper limit number, the determination unit 67 can cause the write processing unit 62 to continue the write processing for the second track STR1 and cause the management unit 65 to execute the second management instead of the first management.

During the first write period, if determining that the cumulative actual excess amount has exceeded the upper limit threshold value, the determination unit 67 can cause the write processing unit 62 to continue the write processing for the second track STR1, cause the management unit 65 to execute the third management instead of the first management, and cause the correction limit discrimination unit 66 to temporarily update the cumulative actual excess amount obtained by subtracting from the cumulative actual excess amount the actual excess amount measured each time the one or more second corrupted target sectors CSC are formed on the first track STR0.

During the first write period, if determining that the cumulative number has exceeded the upper limit number, the determination unit 67 can cause the write processing unit 62 to continue the write processing for the second track STR1, cause the management unit 65 to execute the third management instead of the first management, and cause the correction limit discrimination unit 66 to temporarily update the cumulative number obtained by subtracting from the cumulative number the number of the second corrupted sectors CSC counted each time the one or more second corrupted target sectors CSC are formed on the first track STR0.

Next, a nonvolatile recording medium that is a destination of saving the original data in the buffer memory 80 will be described.

The first track STR0 and the second track STR1 are located in a user data area U of the recording layer L. The nonvolatile recording medium may be, for example, the system area S different from the user data area U of the recording layer L.

In this example, a band including the first track STR0 and the second track STR1 among a plurality of bands BA is called a first band BA. To save the data belonging to the third group to the system area S, the management unit 65 needs to use the write head WHD.

An example of the timing when the management unit 65 saves the the data belonging to the third group to the system area S may be the timing after ending the write processing of writing the second data to a plurality of target sectors RSC of the second track STR1 (i.e., after the first write period).

Alternatively, an example of the timing when the management unit 65 saves the data belonging to the third group to the system area S may be the timing after ending the write processing of writing the data to a plurality of tracks STR of the first band BA (i.e., after the first write period).

The nonvolatile recording medium may be, for example, the nonvolatile memory 90 located outside the disk DK.

In this case, an example of the timing when the management unit 65 saves the data belonging to the third group to the nonvolatile memory 90 may be the timing after determining that the error correction of the first user data on the first track STR0 has exceeded the limit (i.e., during the first write period). This is because the write processing for the second track STR1 and the operation of saving to the nonvolatile memory 90 can be executed simultaneously.

Alternatively, an example of the timing when the management unit 65 saves the the data belonging to the third group to the nonvolatile memory 90 may be the timing after ending the write processing of writing the second data to a plurality of target sectors RSC of the second track STR1 (i.e., after the first write period).

Alternatively, an example of the timing when the management unit 65 saves the the data belonging to the third group to the nonvolatile memory 90 may be the timing after ending the write processing of writing the data to a plurality of tracks STR of the first band BA (i.e., after the first write period).

### Examples of First Method of the Second Write Operation

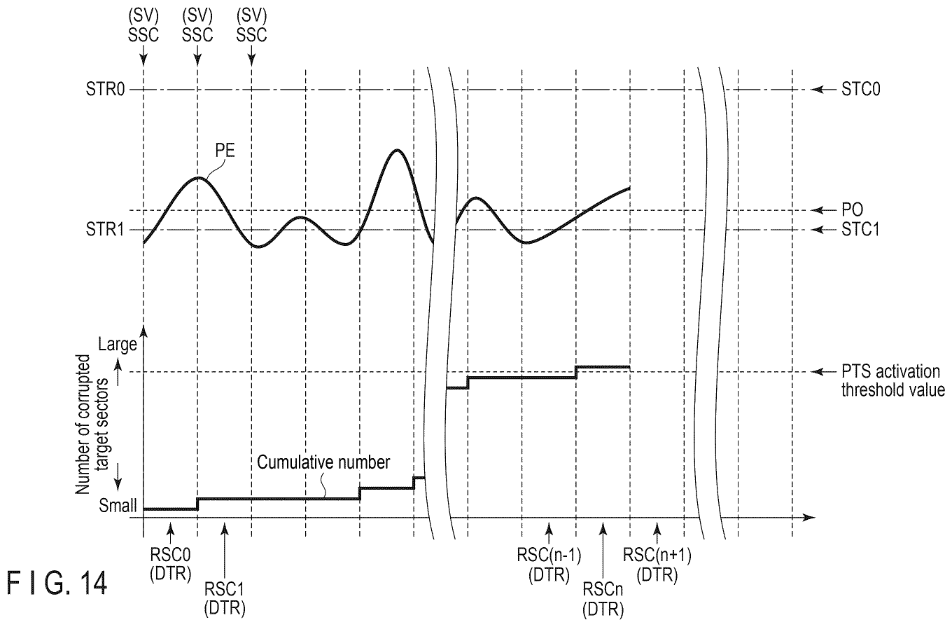

Next, examples of the first method of the second write operation will be described. FIG. 14 is a chart showing the change in positioning error PE and the change in cumulative number of corrupted target sectors CSC in the case of executing the write processing for the second track STR1 in the first method of the second write operation, and showing a case where the cumulative number exceeds a PTS activation threshold value during the write processing for the n-th target sector RSCn of the second track STR1.

As shown in FIG. 14, a plurality of target sectors RSC (data areas DTR) and a plurality of servo sectors SSC (servo areas SV) are arranged in a circumferential direction. Each time the read head RHD passes through the servo sector SSC, the position of the head HD in the radial direction d1 can be corrected. This processing is effective when the head HD is in a vibrating state due to influences of the seek operation, and the like. However, the proportion (size) of the servo sector SSC to the track STR is smaller than the proportion (size) of the target sector RSC to the track STR. For this reason, it is difficult to sufficiently correct the position of the head HD in the radial direction d1.

As a result, if the write processing is executed for the plurality of target sectors RSC of the second track STR1, the positioning error PE may exceed the reference radius position PO a plurality of times. The determination unit 67 can determine whether to activate the PTS by monitoring the cumulative number to exceed the PTS activation threshold value in relation to the corrupted target sectors CSC on the first track STR0.

In the example of FIG. 14, a point of time at which the write processing unit 62 executes the write processing up to the n-th target sector RSCn of the second track STR1 is focused. At this time, it can be recognized that the cumulative number exceeds the PTS activation threshold value. The determination unit 67 can activate the PTS. The determination unit 67 does not execute the write processing for the target sector RSC following the n+1-th target sector RSC(n+1) of the second track STR1, but can save the remaining data that could not be written to the second track STR1 to a track other than the first track STR0 and the second track STR1.

The reason why the determination unit 67 cannot execute the write processing for the target sector RSC of the second track STR1 following the n+1-th target sector RSC(n+1) is that a situation that the error correction executed by the error correction unit 64 may exceed the limit cannot be allowed. As described above, the first method of the second write operation can hardly contribute to improvement of the write performance of the magnetic disk device 1.

### Examples of Second Method of the Second Write Operation (Information: Cumulative Number)

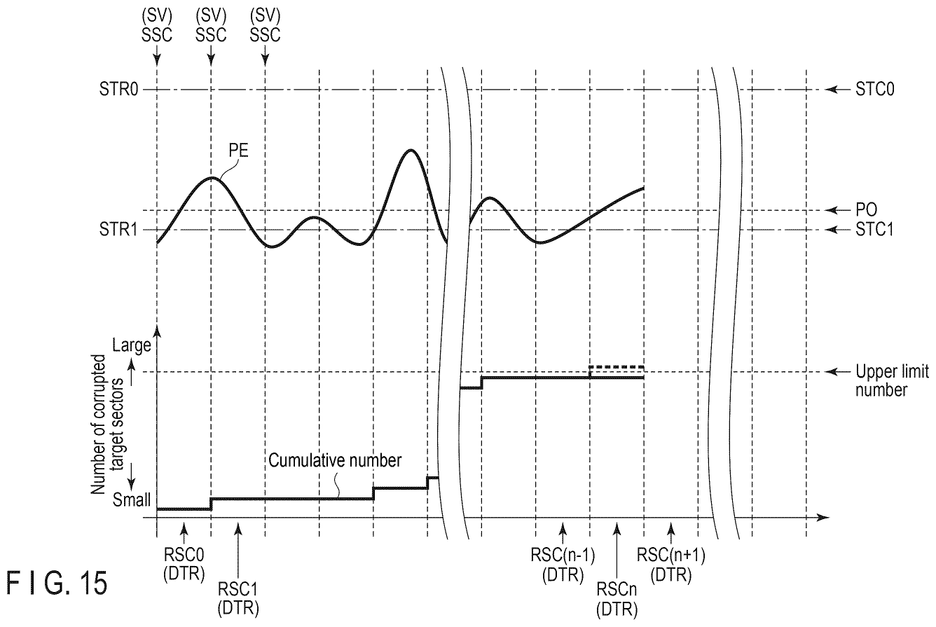

Next, examples of the second method of the second write operation will be described. FIG. 15 is a chart showing the change in positioning error PE and the change in cumulative number of corrupted target sectors CSC in a case of executing the write processing for the second track STR1 in the second method of the second write operation, and showing a case where the cumulative number exceeds an upper limit number during the write processing for the n-th target sector RSCn of the second track STR1. In this case, the information obtained by the correction limit discrimination unit 66 is the cumulative number.

As shown in FIG. 15, the determination unit 67 can determine which of the first to third managements the management unit 65 is caused to execute by monitoring the cumulative number to exceed the upper limit number in relation to the corrupted target sectors CSC on the first track STR0.

In the example of FIG. 15, a point of time at which the write processing unit 62 executes the write processing up to the n-th target sector RSCn of the second track STR1 is focused. At this time, it can be recognized that the cumulative number exceeds the upper limit number. Even if the cumulative number exceeds the upper limit number, the determination unit 67 can cause the write processing unit 62 to continue the write processing for the second track STR1, and the degradation in write performance can be suppressed.

In addition, the determination unit 67 can cause the correction limit discrimination unit 66 to update the cumulative number obtained by subtracting the number of the second corrupted target sectors CSC from the cumulative number, by causing the management unit 65 to execute the third management. In other words, it is possible to update the state of the cumulative number from a state represented by a broken line to a state represented by a solid line in FIG. 15. For this reason, a state in which the track-based error correction for the first track STR0 does not reach the limit can be maintained.

### Examples of Second Method of the Second Write Operation (Information: Cumulative Actual Excess Amount)

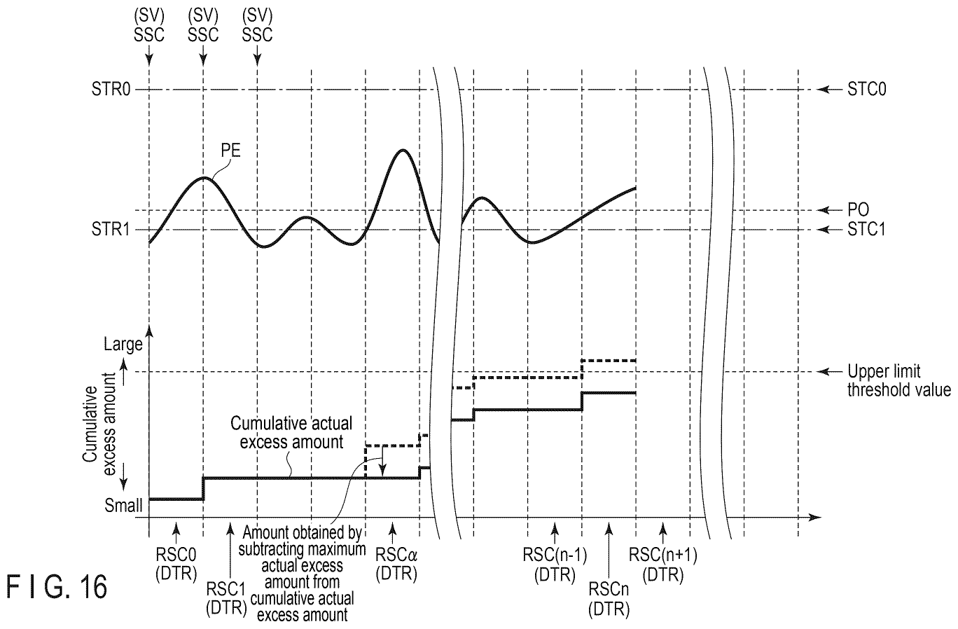

Next, examples of the second method of the second write operation will be described. FIG. 16 is a chart showing the change in positioning error PE and the change in cumulative actual excess amount in a case of executing the write processing for the second track STR1 in the second method of the second write operation, and showing a case where the cumulative actual excess amount exceeds an upper limit threshold value during the write processing for the n-th target sector RSCn of the second track STR1. In this case, the information obtained by the correction limit discrimination unit 66 is the cumulative actual excess amount.

As shown in FIG. 16, the determination unit 67 can determine which of the first to third managements the management unit 65 is caused to execute by monitoring the cumulative actual excess amount to exceed the upper limit threshold value in relation to the corrupted target sectors CSC on the first track STR0.

In the example of FIG. 16, a point of time at which the write processing unit 62 executes the write processing up to the n-th target sector RSCn of the second track STR1 is focused. At this time, it can be recognized that the cumulative actual excess amount exceeds the upper limit threshold value. Even if the cumulative actual excess amount exceeds the upper limit threshold value, the determination unit 67 can cause the write processing unit 62 to continue the write processing for the second track STR1, and the degradation in write performance can be suppressed.

In addition, the determination unit 67 can cause the correction limit discrimination unit 66 to update the cumulative actual excess amount obtained by subtracting from the cumulative actual excess amount the actual excess amount, by causing the management unit 65 to execute the third management. In other words, it is possible to update the state of the cumulative actual excess amount from a state represented by a dashed line to a state represented by a solid line in FIG. 16. For this reason, a state in which the track-based error correction for the first track STR0 does not reach the limit can be maintained.

The situation that the actual excess amount becomes maximum at the time of executing the write processing for α-th target sector RSCα during a period of executing the write processing for the target sectors from the 0-th target sector RSC0 to the n-th target sector RSCn of the second track STR1, will be focused.

When the determination unit 67 saves the original data from the buffer memory 80 to the system area S, the determination unit 67 can save the original data of the data of the most corrupted target sector RSCα on the first track STR0 to the system area S in priority. In this case, the correction limit discrimination unit 66 can update the cumulative actual excess amount by subtracting from the cumulative actual excess amount the actual excess amount at the time of executing the write processing for the target sector RSCα on the second track STR1. Since the cumulative actual excess amount can be updated to the smallest amount, the cumulative actual excess amount can hardly exceed the upper limit threshold value.

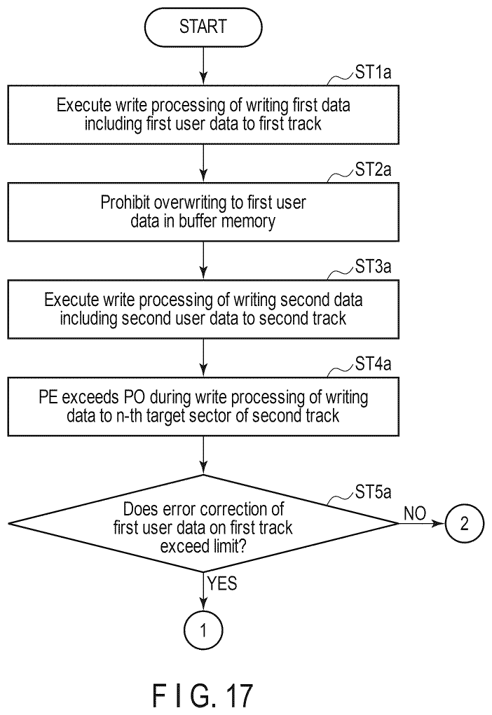

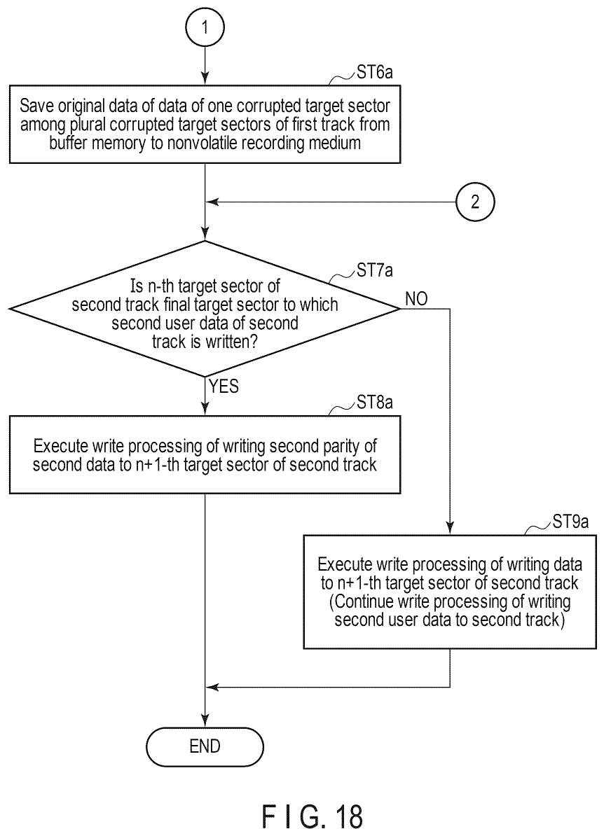

Next, an example of the second method of the second write operation will be described with reference to a flowchart. FIG. 17 is a flowchart showing a write processing method for the n-th target sector RSCn of the second track STR1, of the write processing method of the embodiment, illustrating a case where the magnetic disk device 1 adopts the second method of the second write operation during the first write period. FIG. 18 is a flowchart showing the write processing method following FIG. 17.

As shown in FIG. 17, FIG. 1, and FIG. 12, when the second method of the second write operation starts, first, the write processing unit 62 executes the write processing of writing the first data including the first user data to the first track STR0, in step ST1a. Then, in step ST2a, the management unit 65 executes the first management of prohibiting overwriting the first user data in the buffer memory 80. After that, in step ST3a, the write processing unit 62 executes the write processing of writing the second data including the second user data to the second track STR1.

In step ST4a, the processing results in the situation that the positioning error PE is displaced beyond the reference radius position PO at the time of the write processing of writing the data to the n-th target sector RSCn of the second track STR1. Then, in step ST5a, the determination unit 67 determines whether the error correction of the first user data on the first track STR0 exceeds the limit, based on the information obtained by the correction limit discrimination unit 66.

As shown in FIG. 18, FIG. 1, and FIG. 12, if the error correction of the first user data on the first track STR0 exceeds the limit (step ST5a, YES), the processing shifts to step ST6a, the determination unit 67 saves the original data of the data of one corrupted target sector CSC among the plurality of corrupted target sectors CSC of the first track STR0 from the buffer memory 80 to a recording medium (for example, the system area S), and the processing shifts to step ST7a.

In contrast, if the error correction of the first user data on the first track STR0 does not exceed the limit (step ST5a, NO), the processing shifts to step ST7a.

In step ST7a, the determination unit 67 determines whether the n-th target sector RSCn of the second track STR1 is the last target sector RSC to which the second user data is written, of the second track STR1. If the n-th target sector RSCn of the second track STR1 is the last target sector RSC (step ST7a, YES), the processing shifts to step ST8a, and the write processing unit 62 executes the write processing of writing the second parity of the second data to the n+1-th target sector RSC(n+1) of the second track STR1. Writing the second parity to the second track STR1 is ended, and the write processing for the first track STR0 and the second track STR1 is thereby ended.

In contrast, if the n-th target sector RSCn of the second track STR1 is not the last target sector RSC (step ST7a, NO), the processing shifts to step ST9a, and the write processing unit 62 executes the write processing of writing the data to the n+1-th target sector RSC(n+1) of the second track STR1. In other words, the write processing unit 62 continues the write processing of writing the second data to the second track STR1. Then, writing the second user data and the second parity to the second track STR1 is ended, and the write processing for the first track STR0 and the second track STR1 is thereby ended.

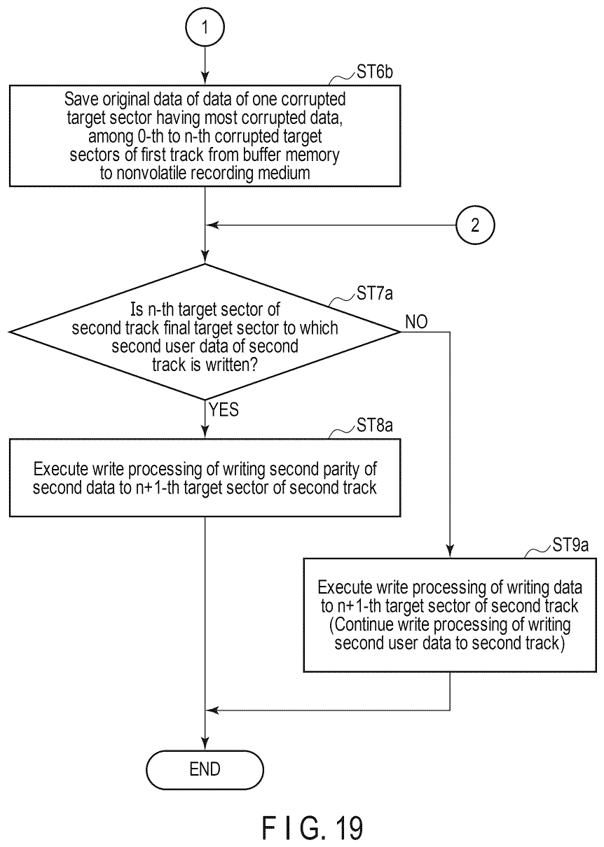

Step ST6a of FIG. 18 can be changed. FIG. 19 is a flowchart showing a modified example of the write processing method, following FIG. 17.

As shown in FIG. 19, FIG. 1, and FIG. 12, step ST6a in FIG. 18 can be replaced with step ST6b in FIG. 19. Incidentally, FIG. 19 is the same as FIG. 18 except for step ST6b.

In step ST6b, the determination unit 67 may save the original data of the data of one corrupted target sector CSC having the most corrupted data, among the target sectors from the 0-th target sector RSC0 to the n-th target sector RSCn of the first track STR0, from the buffer memory 80 to the recording medium (for example, the system area S), and the processing may shift to step ST7a.

According to the magnetic disk device 1 of the embodiment configured as described above, the magnetic disk device 1 comprises the disk DK, the head HD, the read processing unit 63, the write processing unit 62, the error correction unit 64, the buffer memory 80, the management unit 65, the correction limit discrimination unit 66, and the determination unit 67.

During the first write period, the read processing unit 63 executes the seek processing of causing the read head RHD to seek and makes the write head WHD face the second track STR1. Each time the data is written to each target sector RSC of the second track STR1, the correction limit discrimination unit 66 obtains information that the position of the write head WHD is displaced beyond the reference radius position PO in the first direction Da. The management unit 65 executes the first management.

If determining that the error correction of the first user data on the first track STR0, which is executed by the error correction unit 64, does not exceed the limit, based on the information obtained by the correction limit discrimination unit 66, the determination unit 67 can cause the write processing unit 62 to continue the write processing for the second track STR1 and cause the management unit 65 to execute the second management instead of the first management. If determining that the error correction of the first user data on the first track STR0, which is executed by the error correction unit 64, has exceeded the limit, based on the above-described information, the determination unit 67 can cause the write processing unit 62 to continue the write processing for the second track STR1 and cause the management unit 65 to execute the third management instead of the first management.

Then, during the first write period or after the first write period, the determination unit 67 can cause the management unit 65 to execute the processing of saving the data belonging to the third group to the nonvolatile recording medium.

The situation of suspending or ending the write processing for the second track STR1 can be avoided, which can contribute to the improvement of write performance of the magnetic disk device 1.

Furthermore, unlike the activation of the PTS, the separated data does not need to be read while executing the seek operation, which can contribute to the improvement of the read performance.

In addition, since no activation of PTS is executed, the target sectors RSC of the first track STR0 and the second track STR1 cannot be empty sectors ESC. Therefore, the efficiency of use of the first track STR0 and the second track STR1 can be increased and the areal density capacity (ADC) of the data on the disk DK can be improved.

Furthermore, as regards the excessive corrupted data for which the error correction executed by the error correction unit 64 exceeds the limit, among the corrupted data of the first track STR0, the original data of the excessive corrupted data can be saved from the buffer memory 80 to a recording medium (for example, the system area S). The excess corrupted data on the first track STR0 can be ensured indirectly. Based on the above, the magnetic disk device 1 capable of improving the areal recording density of the data on the disk DK and suppressing the degradation in write performance can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is

1. A magnetic disk device comprising:
a disk including a first data track and a second data track adjacent to each other in a recording layer, the first data track and the second data track each including a plurality of target sectors being targets to which data is to be written, the first data track being located in a first direction parallel to a radial direction of the disk as viewed from the second data track;
a head including a write head writing data to the recording layer and a read head reading data from the recording layer;
a read processing unit capable of executing seek processing of causing the read head to seek;
a write processing unit capable of executing write processing of writing data to the recording layer;
an error correction unit executing error correction of data in one or more corrupted target sectors in which data is considered to be corrupted, among the plurality of target sectors of the first data track;
a buffer memory capable of holding a plurality of elements of data including first user data and second user data;
a management unit capable of selectively executing first management of prohibiting overwrite to the first user data in the buffer memory, second management of permitting overwrite to all elements of the first user data in the buffer memory, and third management of permitting overwrite to data belonging to a first group and a second group among the first user data in the buffer memory and prohibiting overwrite to data belonging to a third group among the first user data in the buffer memory;
a correction limit discrimination unit; and
a determination unit,
wherein
during a first write period being a period elapsed after the write processing unit executes the write processing of writing first data including the first user data to the plurality of target sectors of the first data track, and the period during which the write processing unit executes the write processing of writing second data including the second user data to the plurality of target sectors of the second data track,
the read processing unit executes seek processing of causing the read head to seek and makes the write head face the second data track,
each time data is written to each of the target sectors of the second data track, the correction limit discrimination unit obtains information that a position of the write head is displaced beyond a reference radius position in the first direction, and
the management unit executes the first management, and
if determining that the error correction of the first user data on the first data track, which is executed by the error correction unit, does not exceed a limit, based on the information obtained by the correction limit discrimination unit, the determination unit causes the write processing unit to continue the write processing for the second data track and causes the management unit to execute the second management instead of the first management, and
if determining that the error correction of the first user data on the first data track, which is executed by the error correction unit, exceeds the limit, based on the information, the determination unit causes the write processing unit to continue the write processing for the second data track and causes the management unit to execute the third management instead of the first management, and
during the first write period or after the first write period,
the determination unit causes the management unit to execute processing of saving data belonging to the third group to a nonvolatile recording medium,
the data belonging to the first group is original data of the data of one or more target sectors in which the data is determined to be uncorrupted, among the plurality of target sectors of the first data track,
the data belonging to the second group is original data of the data of one or more first corrupted target sectors in which the data is determined to be corrupted, among the plurality of target sectors of the first data track, and original data of the data within a range of being subjected to the error correction executed by the error correction unit, and
the data belonging to the third group is original data of the data of one or more second corrupted target sectors in which the data is determined to be corrupted, among the plurality of target sectors of the first data track, and original data of the data which leaks from the range of being subjected to the error correction executed by the error correction unit.

2. The magnetic disk device of claim 1, wherein
the first user data is written or both the first user data and a first parity generated based on the first user data are written to all target sectors of the first data track, and
the second user data is written or both the second user data and a second parity generated based on the second user data are written to all target sectors of the second data track.

3. The magnetic disk device of claim 1, wherein
each time the second data is written to each of the target sectors of the second data track, the correction limit discrimination unit measures an actual excess amount of the position of the write head, which is displaced beyond the reference radius position in the first direction, and updates a cumulative actual excess amount, which is a cumulative total of the actual excess amount,
the information obtained by the correction limit discrimination unit is the cumulative actual excess amount, and
during the first write period,
if determining that the cumulative actual excess amount is smaller than or equal to an upper limit threshold value, the determination unit causes the write processing unit to continue the write processing for the second data track and causes the management unit to execute the second management, the upper limit threshold value being a value indicating a limit of the range in which the error correction for the first data track can be executed, and
if determining that the cumulative actual excess amount exceeds the upper limit threshold value, the determination unit causes the write processing unit to continue the write processing for the second data track, causes the management unit to execute the third management, and causes the correction limit discrimination unit to temporarily update the cumulative actual excess amount obtained by subtracting from the cumulative actual excess amount the actual excess amount measured each time the one or more second corrupted target sectors are formed on the first data track.

4. The magnetic disk device of claim 3, wherein
when the actual excess amount in a case where each of the one or more first corrupted target sectors are formed on the first data track is referred to as a first actual excess amount and
when the actual excess amount in a case where each of the one or more second corrupted target sectors are formed on the first data track is referred to as a second actual excess amount,
the second actual excess amount is more than or equal to the first actual excess amount.

5. The magnetic disk device of claim 3, wherein
the correction limit discrimination unit counts the number of the one or more corrupted target sectors on the first data track and updates the cumulative number that is the cumulative count,
the information obtained by the correction limit discrimination unit further includes the cumulative number, and
during the first write period,
if determining that the cumulative actual excess amount is smaller than or equal to an upper limit threshold value and determining that the cumulative number is smaller than or equal to the upper limit number, the determination unit causes the write processing unit to continue the write processing for the second data track and causes the management unit to execute the second management, the upper limit number being the number indicating a limit of the range in which the error correction for the first data track can be executed,
if determining that the cumulative actual excess amount exceeds the upper limit threshold value, the determination unit causes the write processing unit to continue the write processing for the second data track, causes the management unit to execute the third management, and causes the correction limit discrimination unit to temporarily update the cumulative actual excess amount obtained by subtracting from the cumulative actual excess amount the actual excess amount measured each time the one or more second corrupted target sectors are formed on the first data track,
if determining that the cumulative number exceeds the upper limit number, the determination unit causes the write processing unit to continue the write processing for the second data track, causes the management unit to execute the third management, and causes the correction limit discrimination unit to temporarily update the cumulative number obtained by subtracting from the cumulative number the number of the second corrupted target sectors counted each time the one or more second corrupted target sectors are formed on the first data track, and
if the cumulative number exceeds the upper limit number,
the total number of the one or more first corrupted target sectors matches the upper limit number.

6. The magnetic disk device of claim 1, wherein
the correction limit discrimination unit counts the number of the one or more corrupted target sectors on the first data track and updates the cumulative number that is the cumulative count,
the information obtained by the correction limit discrimination unit is the cumulative number,
during the first write period,
if determining that the cumulative number is smaller than or equal to an upper limit number, the determination unit causes the write processing unit to continue the write processing for the second data track and causes the management unit to execute the second management, the upper limit number being the number indicating a limit of the range in which the error correction for the first data track can be executed, and
if determining that the cumulative number exceeds the upper limit number, the determination unit causes the write processing unit to continue the write processing for the second data track, causes the management unit to execute the third management, and causes the correction limit discrimination unit to temporarily update the cumulative number obtained by subtracting from the cumulative number the number of the second corrupted target sectors counted each time the one or more second corrupted target sectors are formed on the first data track, and
if the cumulative number exceeds the upper limit number,
the total number of the one or more first corrupted target sectors matches the upper limit number.

7. The magnetic disk device of claim 1, wherein
the first data track and the second data track are located in a user data area of the recording layer, and
the nonvolatile recording medium is a system area of the recording layer.

8. The magnetic disk device of claim 7, wherein
the user data area includes a plurality of bands each including a plurality of data tracks,
the plurality of bands include a first band including the first data track and the second data track, and
the timing of the management unit saving the data belonging to the third group to the system area is
the timing after the write processing of writing the second data to the plurality of target sectors of the second data track is ended, or
the timing after the write timing of writing the data to the plurality of data tracks of the first band is ended.

9. The magnetic disk device of claim 1, wherein
the nonvolatile recording medium is a nonvolatile memory located outside the disk.

10. The magnetic disk device of claim 9, wherein
the user data area of the recording layer includes a plurality of bands each including a plurality of data tracks,
the plurality of bands include a first band including the first data track and the second data track, and
the timing of the management unit saving the data belonging to the third group to the system area of the recording layer is
the timing after the determination unit determines that the error correction of the first user data on the first data track exceeds a limit, or
the timing after the write processing of writing the second data to the plurality of target sectors of the second data track is ended, or
the timing after the write processing of writing the data to the plurality of data tracks of the first band is ended.

11. The magnetic disk device of claim 1, wherein
the write processing unit is in a type of shingled magnetic recording of making the second data of the second data track overlap with the first data of the first data track in an overwriting direction opposite to the first direction and writing the data.
